(19) United States
(12) Patent Application Publication
(10) Pub. No.: US 2014/0247246 A1
(43) Pub. Date: Sep. 4, 2014

(54) TACTILE TO TOUCH INPUT DEVICE

(71) Applicant: Daryl D Maus, Groveland, IL (US)

(72) Inventor: Daryl D Maus, Groveland, IL (US)

(21) Appl. No.: 14/274,690

(22) Filed: May 10, 2014

Related U.S. Application Data
(63) Continuation-in-part of application No. 13/677,357, filed on Nov. 15, 2012.
(60) Provisional application No. 61/823,943, filed on May 16, 2013.
(60) Provisional application No. 61/878,155, filed on Sep. 16, 2013.
(60) Provisional application No. 61/926,430, filed on Jan. 13, 2014.

(51) Int. Cl. G06F 3/044

(52) U.S. Cl. CPC G06F 3/044
USPC 345/174

(57) ABSTRACT

An interface is provided for a device having a touch screen such as a smart phone or tablet computer that extends the touch screen input to areas outside the touch screen area. The interface has a housing which attaches to the device. One or more input controls are mounted on the housing. The controls can be joysticks, buttons, touch pads, levers, triggers, keyboards, etc. Conductive pads are connected to the housing and capacitively interact with the touch screen. The interface contains circuitry that transmits an electrical or capacitive signal from the user's manipulation of the controls to the conductive pads in order to activate selected areas of the touch screen. The housing may be made in multiple pieces to connect to different sides of the touch screen device.

This patent application is a continuation-in-part of U.S. patent application Ser. No. 13/677,357 filed Nov. 15, 2012 entitled “MULTI-TOUCH INPUT DEVICE” which claims priority to provisional patent application 61/590,846 filed Jan. 26, 2012, and provisional patent application 61/560,758 filed Nov. 16, 2011. This patent application also claims priority to provisional patent application 61/823,943 filed May 16, 2013, provisional patent application 61/878,155 filed Sep. 16, 2013 and provisional patent application 61/926,430 filed Jan. 13, 2014. All of these applications are incorporated by reference in their entirety for all purposes.

### FIELD OF THE INVENTION

The invention relates generally to the field of portable electronic devices with a touchscreen, such as mobile phones, smart phones, tablet PCs and PDAs. More specifically, the present invention relates to the field of interaction with these devices through a remote input that activates a touchscreen input.

### BACKGROUND OF THE INVENTION

Touch screens are becoming the predominant way humans interact with mobile phones, smart phones, tablet PCs and PDAs. While touch screens have improved the user interface with customizable and flexible input screens which utilize tapping, swiping and multi-touch gestures, touch screens still largely continue to limit users holding a phone in a portrait orientation to a single input i.e. their forefinger or when the phone is held in a landscape orientation a dual input i.e. their left and right thumbs. This makes controlling programs designed to operate on console gaming units and PCs difficult.

A further limitation of a smart phone touchscreen is, that on a small screen, thumbs and fingers used for inputting obscure a substantial area of the screen. The input device such as a finger, thumb, or stylus is large when compared to the resolution of the data displayed. Some touch screen improvements compound this problem. For instance, high resolution screens allow more information to be displayed, unfortunately that means a finger covers more information. It also makes it more difficult to precisely locate an input, inserting an editing cursor between small letters in small words on a small screen with a big finger is difficult.

More specifically, touch screens have substantial limitations for videogame players who are used to the remote input devices currently available for console games. These remote input devices or gamepads allow the user to simultaneously, quickly and easily move, jump, shoot, and more. The raised and sometimes textured buttons on current remote input devices provide tactile feedback enabling the user to easily position their fingers on the buttons. Touchscreens, on the other hand are flat and featureless requiring the user to look at their fingers to confirm they are in the proper place thereby distracting from their game play or other use of the device.

Touchscreen devices also have limitations for traditional PC users who cannot use the inputs they are accustomed to when interacting with a touch screen. For general PC operation most users are accustomed to moving a cursor on the screen with a mouse then using left and right mouse “clicks” for selecting and initiating inputs. Particularly useful is the ability to use the mouse to precisely locate a cursor and then have quick access to context-sensitive menus with a right-click. For entering text and advanced gaming most PC users are accustomed to standard QWERTY keyboards where they can use multiple fingers and simultaneous inputs for shift, number lock, function keys, macros and other required inputs.

Additionally, single-handed operation of a touch screen smart phone while the user is holding the phone is difficult. Phone manufacturers have attempted to overcome this limitation with speech recognition. There still remains significant limitations for those with handicaps that necessitate single-handed operation and for those users who only have one hand available, i.e. they are driving, or for when a spoken input is not appropriate or possible such as in classrooms.

Devices incorporating a touchscreen also incorporate additional user inputs such as power and home switches, volume controls, ringer controls, and other controls for specific operations. These inputs are fixed in the chassis of the device, require circuits and wiring, and are configured as separate inputs to various controllers and the CPU. The signals from these inputs require software and programming code.

The current combination of the requirements for a touchscreen and these fixed inputs has limited the input capability of mobile devices particularly as it relates to video game input controls.

Typically any additional custom user inputs, such as those for playing a video game, require a complex separate control device with circuits, housings, and batteries that connects to the device through a wire, blue tooth interface, NFC, wifi or other additional input.

This deficiency in current product architecture adds complexity and cost to the design of a touchscreen device. Further this complexity lengthens the development cycle and the engineering cost of design and redesign. This limits the breadth of the product line and thereby the customization of the device for smaller markets, for instance, smartphone manufacturers do not provide both right-hand and left-hand versions of their phones

Another deficiency of many current touchscreen devices is that they do not fully utilize the input capability of existing multi-touch controllers used in mobile devices. A typical multi-touch controller has the ability to discern 10 distinct touch events but practically a mobile device user uses one hand to hold the device and only uses one or two fingers of the other hand to input into the device.

Further because user inputs are generally limited to the touchscreen the user's touchscreen inputs block the viewing screen and repetitive user inputs such as in game play chronically obscure the screen.

Accordingly, the present invention addresses these deficiencies by providing an enhanced user interface for devices with touchscreen inputs through a novel mobile controller or multi-touch off-screen input device which greatly expands the user interface with touch screen devices.

### SUMMARY OF THE INVENTION

One object of the current invention is to create a novel mobile game platform. A typical game platform such includes a computer (Xbox 360 and Playstation), a screen (the TV), a tactile controller and game software. When the mobile controller embodiment of the invention is combined with a mobile touchscreen device, which contains a computer and touchscreen, a mobile game platform is created.

A further object of the present invention is to overcome the limitations of a touch screen interface by attaching mechanical and electrical devices to a touch screen enabled mobile device. The invention translates the off screen movements of the user's fingers as applied to tactile mechanical switches arranged like a typical gaming console controller to capacitance pads that interact with the touch screen thereby providing multiple inputs. In this manner, the invention would simulate the play action of a console game controller while playing games on a touch screen device. A still further advantage is that the housing of the mobile controller provides an ergonometric grip and added security against dropping the device. A further advantage of the invention is that it allows the mobile controller to be readily attached and detached from a smart phone or mobile tablet

The invention's mobile controller additional inputs would greatly benefit gamers playing videogames. The current input limitations of touch screens greatly impair game play and have largely prevented the migration of most popular console and PC games to smart phones. For instance, the addition of switched inputs would allow a user to fire a weapon and jump in shooter games or, in role-playing games to rapidly and easily choose submenus and items. The addition of joysticks or thumb pads would allow the user to simultaneously move in multiple axis, pan the camera and aim a weapon.

A further advantage of the invention is that it can be incorporated into a mobile device case and utilize a moveable input lever that can be stowed or locked into the case or a detachable mechanism when not in use. The design further allows the user to quickly and readily deploy the movable input levers into an active configuration when the user wants to interface with the device. The case can include readily detachable controls to minimize the controls interfering with normal phone usage. Further, the case can incorporate a screen protector with transparent conductors thereby eliminating any overlay of the device housing on the touchscreen.

A further object of the invention is that it can be incorporated into a transparent screen overlay or screenprotector and provide off-screen tactile inputs to the touchscreen on mobile devices, automatic teller machines, medical devices and other equipment with a touchscreen thereby replacing hardwired switches and other controls. By replacing these controls with a removable touchscreen overlay these devices can be simplified, lowered in cost, easily be upgraded and the number and the placement of user inputs readily modified.

A further object of the invention is to improve the functionality of touchscreen devices by expanding their capability with a touchscreen that includes additional touch sensitive area off the screen that can be signaled by the invention. This would improve the flexibility of all touchscreen devices by providing a removable and replaceable cases and covers with off screen inputs that communicate with touch input areas of the device. This arrangement simplifies mechanical and software design and eliminating the cost, permanence and maintenance of fixed switches and controls used in addition to touchscreen of the device.

Another object of the present invention is to overcome these limitations with the addition of touch pads and external buttons integral to the phone that are located on the side of the phone that enable the user to use the fingers that are naturally used in gripping the phone as additional inputs. When using the phone in the portrait orientation a user generally nestles the phone in their palm and lightly holds the corners between their thumb and forefinger. External buttons or touch pads positioned on or near the corners of the phone in a portrait orientation in what would then be the upper corners could create additional inputs where user naturally holds the phone. Additionally, the user could use their other thumb to activate buttons on the bottom of the smart phone. When the phone is held in the landscape orientation the user generally positions their forefingers on the sides of the phone with the phone resting on their index fingers and held between the tips of their fingers. Switches can be incorporated that are readily activated with a motion of the forefinger similar to pulling a trigger. In both instances their natural grip provides easy access to two or more of the external buttons.

These additional inputs would greatly benefit texting. The current limitation of using two thumbs to operate a QWERTY keyboard forces users to abbreviate, avoid capitalization and omit punctuation. With the present invention the functionality of the on the screen QWERTY keyboard could be expanded by using a remote touch pad as a shift key or to bring up a number and punctuation display or multiple off screen touch pads for screen navigation.

If the user needs to edit text inserting an edit cursor is difficult with a large finger in small text field. With the present invention when an edit cursor is inserted the button keys could now operate individually to zoom in on the cursor or move the cursor. If the user is looking at a map, the a button or combination of buttons could be used to zoom in, to zoom out or pan the screen. This would be particularly helpful for single-handed operation by those with a permanent or temporary disability or when the user is driving.

Additionally, an improvement in the functionality of a touch screen device would be to program a button to simulate a “right click” on a mouse thereby activating the context driven submenus and help screens available in most PC programs.

A directional pad or “Dpad” is one of the original and most widely used tactile user inputs on video game controllers. A Dpad allows the user to operate 4 inputs by rocking a single thumb control in 4 the orthogonal directions. This input is generally used for directional control of a character providing up/down and right/left inputs, hence the term directional control. The rocking motion of the Dpad precludes the operation of opposing inputs such as right/left while allowing the simultaneous operation of adjacent inputs—left/up, up/right, right/down, down/left.

To create a touch signal on a touchscreen device generally requires a capacitive pad the size of a stylus. Creating multiple touch signals requires multiple pads separated by enough distance that adjacent touch inputs will not be recognized as one large touch. For a typical touchscreen device the footprint for 2 inputs is about 0.7 inches and 4 inputs is about 1.5 inches wide. This is a large area for a smartphone. The current invention overcomes this limitation by a novel circuit arrangement that multiplexes multiple input signals across an array of smaller pads thereby compressing the area required for multiple touch inputs. The embodiment of the invention is able to multiplex 4 distinct inputs and 4 distinct combinations of these inputs into the area required for 2 individual inputs.

An aspect of the invention disclosed herein applies to large touchscreens including touchscreens used in mobile computing devices or tablets. These touchscreens are comprised of a transparent capacitive sensing touchpad placed over an LCD video screen. Such capacitance sensing touchpads are generally constructed with transparent ITO conductors which are preferred for their transparency but are expensive and have deficiencies in flexural strength which require structurally rigid materials such as a glass cover and a stiff frame which in turn increase the weight and cost of the tablet.

These deficiencies become significant and costly as the size of the touchscreen increases. This is why handheld personal tablet computing devices are generally limited to a 10″ diagonal size. While high resolution screens have been developed to partially offset this size limitation it remains an issue for users who want a larger image for visual clarity or for a more immersive user experience such as for video gaming.

These deficiencies are even greater with very large fixed touchscreen monitors placed vertically or on a table top where it is physically difficult to reach the middle of the screen and reaching across the screen obscures large areas of the screen. And as a touchscreen monitor increases in size the structural requirements increase exponentially consequently significantly increasing weight and cost.

The current invention overcomes these deficiencies and makes additional improvements by reducing the overlying touch pad area of the touchscreen to a border around the screen. This allows the border to be constructed on a lightweight thin flexible film with transparent conductors. And further, because visual information and attention is largely focused on the middle of the screen the touchpad areas located around the peripheral of the screen can have conductors that need not be entirely transparent. This allows the use of lower cost technology such as printed electronics using transparent inks or very thin lines. These printed conductors substantially lower the cost, weight and the flexural rigidity required of tablets and large touchscreen monitors.

While the invention does limit the touch areas available on the central portions of a touchscreen, when the use of a touchscreen is analyzed most of the user input, such as scrolling and menus, occurs around the edges of the screen, and the screen center is largely reserved for visual information. Nonetheless, these limitations can be offset by carefully constructed fly out or dropdown menus which would reduce the need to touch the central portions of a touchscreen. The user can still have access to inputs across the entire screen by scrolling the screen or providing additional input devices such as separate touchpads, trackballs, joysticks and other inputs which improve the user experience through a tactile input and integrate with the border touch areas to provide an improved user experience.

A large touchscreen embodiment of the invention can be placed on top of or incorporated into a table for use in a home, restaurant, arcade, or sports bar and provide direct touch and tactile input to touch input for multiple users. Alternately the monitor may have no touch surfaces and additional touchscreens or touchpads, adapted for use with tactile input to touch input devices, would be utilized on the table top or on pull out trays. Such an embodiment would be configured to accommodate a place setting for food and drinks and take advantage of the lower off the shelf cost of small touchscreens and a conventional LCD monitor.

The current invention overcomes these deficiencies in touchscreen device architecture with a novel low cost user input architecture that incorporates many or all of the user's inputs into a separate and interchangeable case that uses a touch interface to couple with a core touchscreen device with an expanded touch input capability. This novel architecture creates a distinct and novel Tactile User Interface “TUI” that can be customized and personalized just as the GUI—Graphical User Interface can be customized through custom applications.

Therefore, it is a further object of the invention to lower the complexity and cost of customization of a device to the level that they can be personalized for small groups of users, for example a case embodying the invention can easily be made in both left and right hand models. Users can expand the functionality and extend the utility of their core device with multiple cases optimized for multiple applications such as entertainment, gaming, typing, navigating, etc. Therefore core devices will remain relevant longer and manufacturers of touchscreen devices can extend the product life of their devices.

It is a further object of the invention to provide a combined output from the touchscreen controller in a single format that contains both onscreen touch information and user input information from other user inputs. This combined output will simplify the programming required for an application operating on the device.

It is a further object of the invention to provide an interface that is technically accessible to third party product developers with basic technology such as those vendors that provide protective and fashion cases for mobile devices.

It is a further object of the invention to better utilize the input capability of existing multi-touch controllers used in mobile devices. A typical multi-touch controller has the ability to discern 10 simultaneous distinct touch events but practically a mobile device user uses one hand to hold the device and only use one or two fingers of the other hand to input into the device. The invention will use the full multi-touch capability of a controller to accommodate the full complement of simultaneous inputs required for a full featured video game controller.

It is a further object of the invention to reduce obscuring the viewing screen with the user's fingers. If most user inputs, especially repetitive user inputs, are not kept off the screen they chronically obscure the screen.

It is a further object of the invention to move secondary user inputs off the front of the device which then permits the viewing screen to be as large as possible.

It is a further object of the invention to enable devices that are readily adaptable to different cultures and languages using ready adaptable cases. For example, the same device can use a case design that is familiar and intuitive to English users and a case design that is familiar and intuitive to Kanji users.

### BRIEF DESCRIPTION OF THE DRAWINGS

Embodiments of the invention are illustrated by way of example, not by way of limitation, and the following figures relate to preferred embodiments of the present invention Like reference numerals refer to corresponding parts throughout the several views of the drawings. The invention will be better understood from a reading of the following detailed description, taken in conjunction with the accompanying figures in the drawing in which:

FIG. 1 is a front perspective view of a detachable embodiment of the invention attached to a smart phone.

FIG. 2 is a front perspective view of invention in use.

FIG. 3 is an isometric exploded view of the invention shown in FIG. 1.

FIG. 4 is a front isometric view of a mechanical and electrical embodiment of the invention incorporated into a smart phone case.

FIG. 5 is a front isometric view of several configurations of pistol grip embodiment of the invention.

FIG. 6 is an isometric view of a suction or adhesive applied semi-permanent embodiment of the invention.

FIG. 7 is a front isometric view of a game pad embodiment of the invention that adapts to existing application inputs.

FIG. 8 is a front isometric view of a game pad embodiment of the invention optimized for multiple uses of a smart phone.

FIG. 9 is a front perspective view of a detachable two handled embodiment of the invention attached to a tablet PC.

FIG. 10 is an isometric view of the inputs and outputs of a multiple switch handle.

FIG. 11 is an isometric exploded view of one of the handles shown in FIGS. 9 and 10.

FIG. 12 is a front isometric view of a screen protector embodiment of the invention attached to a smart phone with handles similar to those in FIGS. 9, 10 and 11.

FIG. 13 is a front isometric view of the invention incorporated into the construction of a touchscreen device with additional input accessories.

FIG. 14 is an isometric view of a mobile controller incorporated into a single device with adjustable features to accommodate all smart phones and smart phones in cases.

FIG. 15 is a isometric view of a smart phone with additional capacitive inputs coupled to a smartphone case with custom user inputs.

FIG. 16 is a front perspective view of the invention adapted to provide capacitive input from a multi-key device such as a QWERTY keyboard onto a touch screen enabled tablet PC.

FIG. 17 is a front perspective view of a detachable two handled embodiment of the invention with joysticks attached to a tablet PC.

FIG. 18 is an isometric view of the inputs and outputs of a handle in FIG. 17.

FIG. 19 is an isometric exploded view of one of the handles shown in FIGS. 17 and 18.

FIG. 20 is an isometric exploded view of the printed electronics in FIG. 19.

FIG. 21 is an exploded front isometric view of a smartphone case embodiment of the invention that expands the functionality of smartphone into those of a hand-held game player.

FIG. 22 is an exploded front isometric view of the screen protector of FIG. 21.

FIG. 23 is an isometric view of a smartphone case embodiment of the invention with detachable handles.

FIG. 24 is an exploded isometric view of a handle in FIG. 23.

FIG. 25 is an exploded isometric view of a rotary input embodiment of the invention.

FIG. 26 is a front isometric view of the invention in FIG. 25 attached to a tablet PC.

FIG. 27 is an exploded isometric view of a spring clip embodiment of the invention.

FIG. 28 is a front isometric view of the invention in FIG. 27 attached to a smartphone.

FIG. 29 is an exploded isometric view of the invention adapted to a screen protector with integral switches.

FIG. 30 is a front view of the invention in FIG. 29.

FIG. 31 is an isometric view of a detachable graspable joystick embodiment of the invention attached to a protective cover system.

FIG. 32 is a back view of the protective cover system shown in FIG. 31.

FIG. 33 is view of the assembled components of the invention shown in FIG. 31.

FIG. 34 is an isometric exploded view of the invention shown in FIG. 31.

FIG. 35 is a front perspective view of a clamp on miniature joystick embodiment of the invention adapted for use on a smartphone.

FIG. 36 is an isometric exploded view of the invention shown in FIG. 35.

FIG. 37 is a section view of the invention viewed across the front central axis of the invention in shown in FIG. 35.

FIG. 38 is a front perspective view of the invention embodied in a smartphone case with forefinger slides and detachable joysticks.

FIG. 39 is an isometric exploded view of the invention shown in FIG. 38.

FIG. 40 is a suction attachable circle pad embodiment of the invention.

FIG. 41 is an isometric exploded view of the invention shown in FIG. 40.

FIG. 42 is a front perspective view of three different single axis clip on embodiments of the invention.

FIG. 43 is an isometric exploded view of a touch input single axis embodiment of the invention shown in FIG. 42.

FIG. 44 is an isometric exploded view of a single axis pivot embodiment of the invention shown in FIG. 42.

FIG. 45 is an isometric exploded view of a single axis pivot screen contact embodiment of the invention shown in FIG. 42.

FIG. 46 is an isometric view of two detachable Dpad embodiments of the invention attached to a smartphone.

FIG. 47 is an isometric exploded view of the invention shown in FIG. 46.

FIG. 48 is a right section view of the invention shown in FIG. 46.

FIG. 49 is top view of the arrangement of pads and conductors in the electrical circuit of the invention.

FIG. 50 is a table illustrating the active capacitive pads for each input and combination of inputs of the invention

FIG. 51 is a top view of the arrangement and interaction of the capacitive pads with the touchscreen.

FIG. 52 is an isometric view with a forefinger touchpad exploded for clarity.

FIG. 53 is an isometric view of the invention with a thumb touchpad.

FIG. 54 is an exploded isometric view of the invention with a wraparound touchpad.

FIG. 55 is an isometric view of a table top embodiment of the invention.

FIG. 56 is an isometric view of a table top embodiment utilizing separate input devices

FIG. 57 is an isometric view of a cocktail table embodiment of the invention.

FIG. 58 is an isometric view of a cocktail table embodiment of the invention with secondary touchpad inputs.

FIG. 59 is a trimeric view of a cocktail table embodiment of the invention with secondary touchpads on a pull out tray.

FIG. 60 is a schematic representation of the user input architecture in a device.

FIG. 61 is a schematic representation of the flow of information in a device incorporating the invention.

FIG. 62 is a figurative illustration comparing the user input in a device incorporating the invention with the user input of a typical device.

FIG. 63 is a representation of a capacitance touch sensor panel incorporating the invention.

FIG. 64 is a cross-sectional view of a device incorporating the touch sensor panel of FIG. 63.

FIG. 65 is a perspective view of an embodiment of the invention in a smartphone.

FIG. 66 is a perspective view of an embodiment of the invention in a tablet.

### DETAILED DESCRIPTION

This description is made for the purpose of illustrating the general principles of the invention and should not be taken in a limiting sense. There are numerous models of smart phones and tablets PCs of different sizes with varied placement of screens, controls and lenses, the best interface with these devices results in different preferred embodiments of the invention. For the purpose of disclosing the invention and illustrating the capabilities of the mechanical and electrical multi-touch input device several embodiments are described in detail. One skilled in the art can see numerous possible combinations of the embodiments shown and several additional mechanical and electrical means, derivative of the present invention, that can be used to translate the user's finger input to capacitive charge inputs on a touch screen, including: buttons, switches, wires, ribbons, transparent conductors, moveable conductive pads, conductive adhesives and any other means used to connect and disconnect the user's capacitance to the touch screen.

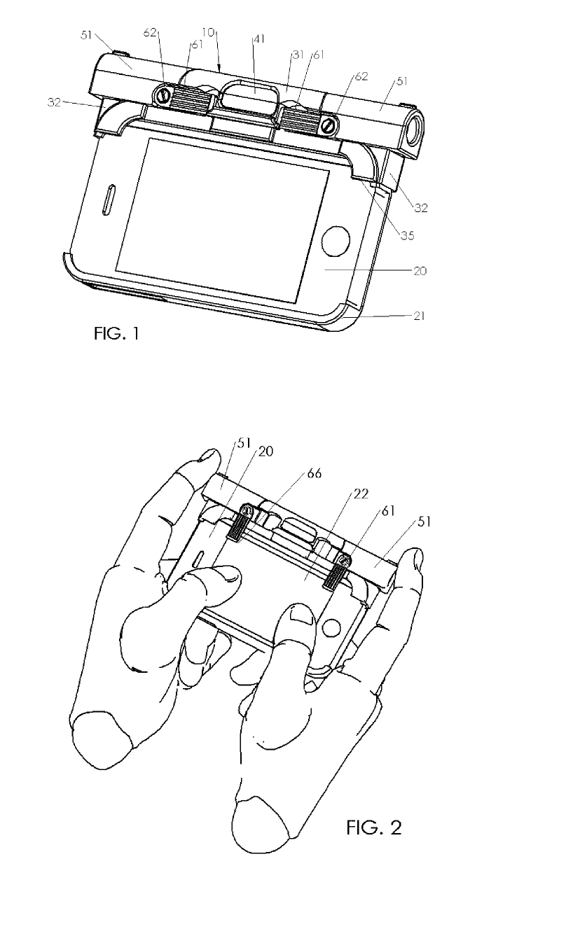

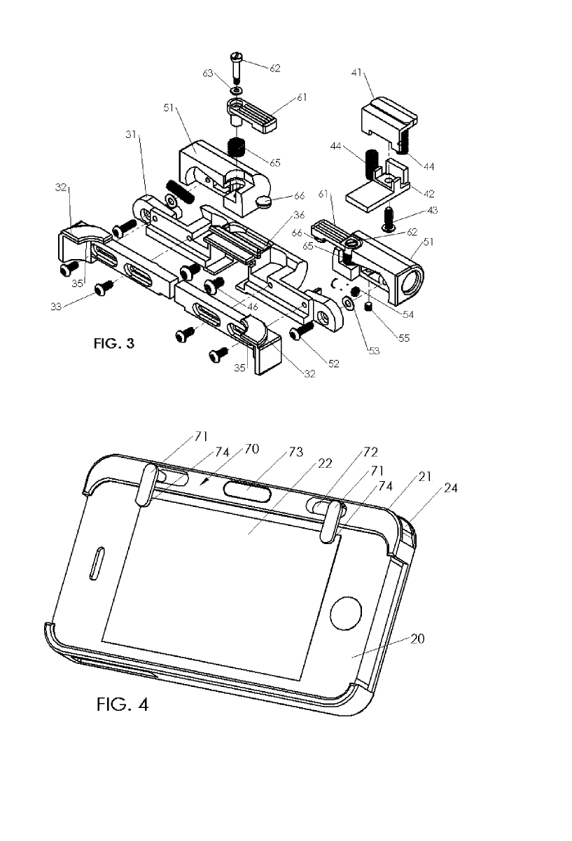

With reference to FIGS. 1-3, the first embodiment of the invention described utilizes a mechanical assembly that readily attaches to a smart phone 20 or smart phone case 21. The mechanism has two finger levers 51 that the user can tap with their index fingers. These finger levers connect the user's capacitance to a stylus lever 61 that is positioned on the touch screen 22 most typically in the upper right and left corners. The users tapping motions thereby couple the user capacitance to the touch screen thereby activating touch screen inputs that can fire a gun, cause a character to jump or any other program input.

The multi-touch input device 10 includes two finger levers 51 a right-hand lever and a left-hand lever mounted to a frame 31. The frame attaches to a smart phone 20 and/or a smart phone in a case with a spring powered clamp assembly 40. The clamp assembly is comprised of a latch 41 that allows the user to release the clamp and a latch clamp 42 that can be adjusted to accommodate smart phones of different thicknesses and is secured to the frame with latch screws 46.

To attach the multi-touch input device 10 to a smart phone 20 the user turns the clamp screw 43 out as required to open the latch clamp 42 wide enough to accommodate the smart phone and then loosens the side clamp screws 33 slightly and slides the side clamps 32 to their fully extended position. The user now positions the multitouch input device on the smart phone in a centered position. The side clamps are slid in until they contact the smart phone. The smart phone is removed and the side clamp screws tightened thereby securing the side clamps in the proper position for the user's device.

With the latch clamp 42 open and the smart phone 20 fully inserted the user tightens the latch screw 43 until it firmly clamps the smart phone between the latch clamp 42 and the side clamp front plates 35. This contact is evidenced by the latch 41 moving off its stop in the frame 31 into the frame slightly. The smart phone is now firmly clamped by the force of the latch springs 44. The user can now quickly and easily release the smart phone by depressing on the latch 41 thereby compressing the latch springs and opening the latch clamp.

The user can easily reinsert the smart phone 20 into the multi-touch input device 10 by depressing the latch 41 thereby holding the latch clamp 42 open and then inserting the smart phone into the device using the side clamps 32 to guide it to a centered position. When the smart phone is firmly in contact with device the user releases the latch and the latch clamp secures it in place.

To move the active components of the multi-touch input device 10 from its stowed configuration to its operating configuration the user holds the smart phone 20 in the landscape position as they normally would. They use their thumbs to depress the stylus levers 61 and move them from their latched position parallel to the finger lever 51 away from the phone and free of the stylus latch plate 36 on the frame 31. The user then allows the stylus to rise upwards powered by the lever spring 54. The user then releases the stylus levers and moves them utilizing the force of the stylus spring 65 into their operating position normal to the finger lever 51. The moveable operating components of the multi-touch input device 10 are comprised of a finger lever 51 which is attached to the frame 31 with a lever screw 52 and is spaced from the frame by lever washer 53. The lever compression spring 54 acts on the lever holding it in the open position which is adjusted by the lever limit screw 55. The stylus lever 61 sits on a stylus washer 64 and is attached to the lever by a stylus screw 62 seated on a stylus screw washer 63. A torsion spring 65 acts on the stylus to rotate it into a fully open position normal to the finger lever contacting the touchscreen 22.

With reference to FIG. 2, when the user is holding the smart phone 20 as they normally hold it in the landscape position their forefingers can easily tap on the finger lever 51 and their capacitance is coupled to the stylus tip 66. This allows the user to use an intuitive forefinger trigger motion to create an input into the smart phone that fires a gun, operates the shift key, or any additional input programmed into the phone.

With reference to FIG. 4, the second embodiment of the invention described utilizes a mechanical assembly combined with a capacitive link that is compactly integrated into a smart phone case 70. Moveable stylus levers 71 move from a stowed position in a recessed pocket 72 in the case when released by button 73. Stylus tips 74 capacitively couple to the smart phone screen 22 and are coupled by the device to the touch pad 24. The components themselves do not have enough capacitance to activate the touch screen but when the user touches a conducting pad the user's capacitance is electrically coupled to the screen. The user simply taps the touch pad with their finger and their electric charge is coupled to the screen thereby providing an input to the smart phone. The touch pad inputs may be located on any surface or location of the smart phone case that is convenient to the user.

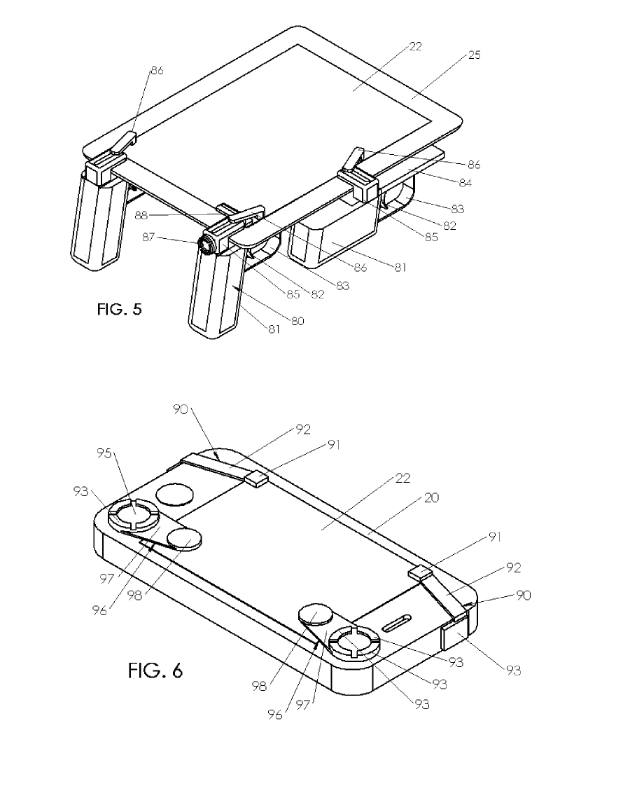

With reference to FIG. 5, the third embodiment of the invention described utilizes a mechanical assembly combined with the capacitive link that is compactly integrated into a pistol shaped assembly 80. The assembly is comprised of a handle 81 designed for the user to grasp modeled after a gun, gaming controller, joystick or other, a trigger 82 as a user input which is protected by a trigger guard 83, that is mounted to a frame 84 that reacts against a clamp 85 to hold a tablet PC or iPad type device 25. The assembly 80 can easily be reconfigured to clamp the tablet 25 on the on the bottom with the handles 81 in a vertical position or on the side with the handles in a horizontal position. A moveable stylus 86 touches the screen 22 and is electrically coupled to a contact that closes when the user pulls the trigger thereby coupling the user's capacitance to the stylus. A variation of this embodiment could include a multi-touch input 87 such as a touch pad, hat switch, thumb stick or other input coupled to a multi-pad array 88. The invention provides a handle, trigger, hat switch or other multi-touch input for use with mobile tablets such as an ipad that allows the user to remotely activate the touch-screen with their forefinger or other fingers and additionally allows the user to more easily grip or hold a mobile tablet.

With reference to FIG. 6, this embodiment of the invention has no moving parts and is not incorporated into a smart phone case. The invention is attached to a smartphone by adhesives, suction or other suitable means. A capacitive link 90 comprised of insulating and conducting materials is applied to a smart phone. A touch pad 93 remote from a touch screen is used to electrically signal a capacitive touch screen 22. A capacitive pad 91 is attached with an adhesive, suction, magnets, spring clips or other means to the screen 22 where the input is desired, a remote touch pad 93 is similarly attached to the mobile device 20 at a location convenient to the user, a conductive wire, film or other conductor 92 connects the two pads. Alternately, the capacitive pad and touch pad and conductor are separate or paired components that are overlapped or connected when applied thereby electrically connecting them in any configuration.

When the user touches the remote touch pad their capacitance is coupled to the screen thereby signaling a touch screen or touch pad to which is attached. A multi-circuit touch pad link 96 incorporates multiple electrically isolated touch pads 93 on a single remote touch pad 95. The multi-circuit touch pad is connected by a multi-conductor film or cable 97 to a multiple input capacitance pad 98 capable of providing multiple separate distinct input signals to the screen. This input would allow the user to interface with common controls such as a hat switch and thumb stick thereby providing simultaneous remote access to common inputs such as up, down, left, and right. This capacitive link embodiment of the invention would work with any smart phone in any case and can be applied and removed as needed.

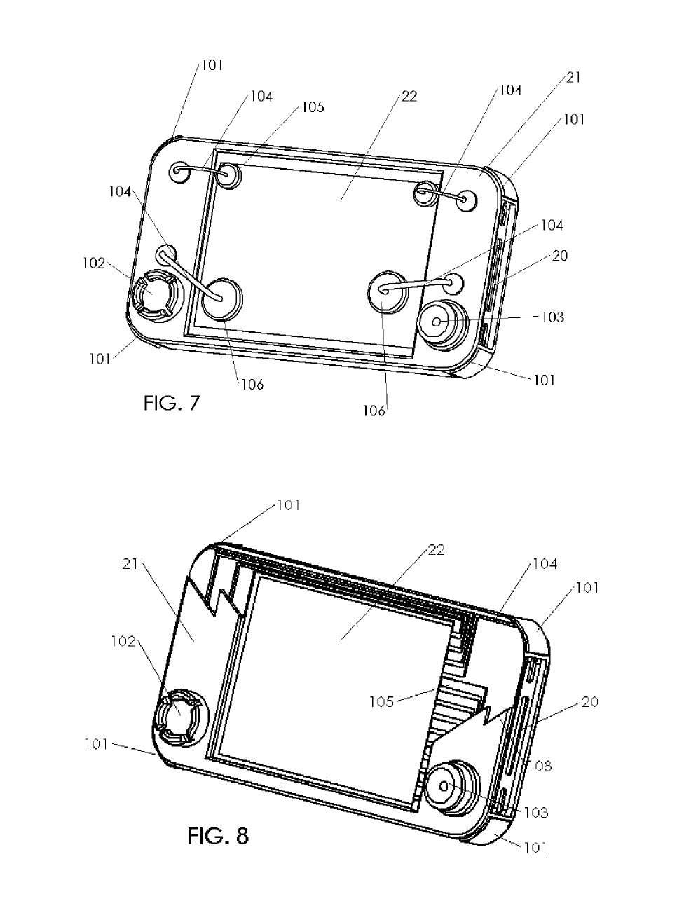

With reference to FIG. 7, a game pad embodiment of the invention that adapts to existing application inputs is described that incorporates touch switches 101, a hat switch 102, a thumb stick 103 or any other type of input device into a smart phone case 21. They can be located to the side or below the screen or any other suitable location. These inputs are coupled by a conductor 104 to capacitive coupling pads 105 or multiple input pads 106 that can be placed on the touch screen 22 of the smart phone 20 at any location. These input pads are attached by suction, adhesion, magnets, springs, clamps or any other means. The conductors are wires, coiled wire, films, plated conductive paths, or any other conductor and are fixed, flexible, retractable or moveable by any means. The user can now interface with the smart phone just as they would with a console gaming station and the invention can interface with any existing software.

With reference to FIG. 8, an embodiment is described that incorporates touch switches 101, a hat switch 102, a thumb stick 103 or any other type of input device into a smart phone case 21. They can be located to the side or below the screen or any other suitable location. The cover 108 of this smart phone case embodiment is shown partially cutaway to illustrate that these inputs are coupled by a wire, conductive film, or any other conductor 104 to an array of capacitive coupling pads that minimally overlay the touch screen 22 along an edge. Software would be programmed to optionally take advantage of these additional inputs and to fit on the modified screen area. A small amount of screen area would be covered but, the overall utility of the smart phone would be enhanced. A further variation on this embodiment would have a movable capacitive pad array that the user could position on or off the screen as they desire thereby allowing access to the full screen area when needed.

Referring to FIGS. 9-11, an easily attachable mobile tablet handle embodiment of the invention is described. The first embodiment described is comprised of two multi-touch input device handle assemblies 210 that readily attach to either side of a mobile device 209. Each handle roughly approximates one half of a typical console game controller. The handle assemblies are installed on a mobile tablet or smart phone by a means that is readily attachable and detachable such as a clamp. When installed on the device a portion of the handle 210 overlays the touch screen 206 and communicates with the touch screen using a capacitive link or circuit. The user operates controls 219 on the handles similar to those found in standard console style gamepads. The invention's controls operate switches that connect the user's capacitance, the capacitance of the device's frame or a standalone capacitor to capacitive pads positioned on the touch screen thereby selectively transferring electrical charge to the mobile device. The invention allows the user to operate the touch screen device without touching the screen.

Referring to FIG. 9, the handles 210, right and left, are attached to a mobile tablet 209. The handles are designed to easily attach to most mobile tablets and smart phones. The handles provide an ergonometric grip and an improved method for holding a tablet and incorporate gaming console style controls 219 that switch a remote capacitive link that provides console controller style gaming input through the touch screen 206 of the mobile device.

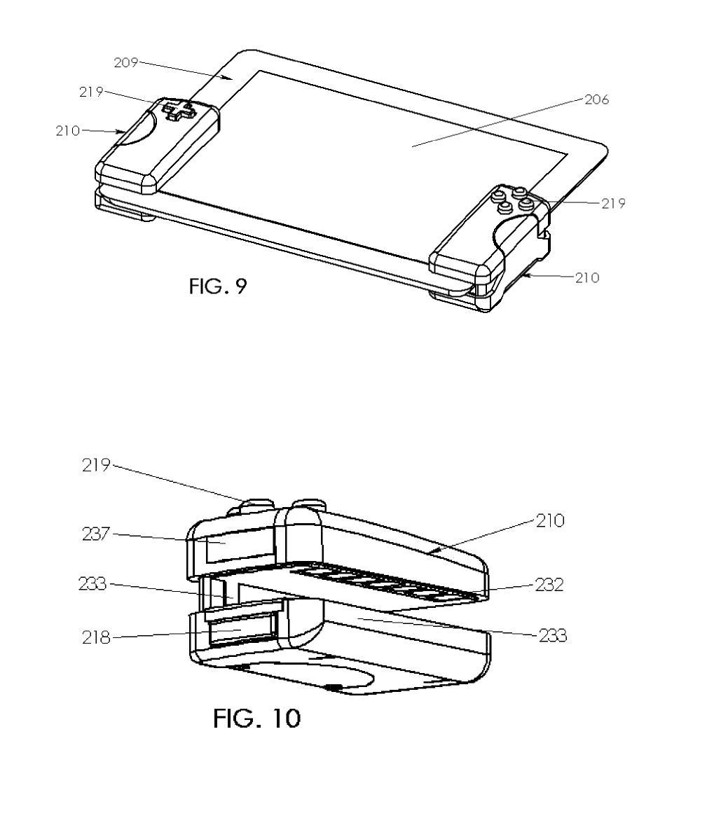

FIG. 10 more clearly illustrates the inputs and outputs of the invention. Handle 210 is designed to clamp onto the tablet and houses the input and output controls. When touched by the user surface contact pads 237 electrically couple the user's capacitance to a corresponding capacitive screen pad 232. Controls 219 located on the top of the handle are generally operated by the thumb and may be configured as multiple buttons, a directional control or any other suitable pattern of input buttons. Shoulder button 218 is located at the end of the handle where the forefinger naturally wraps around the handle. These buttons operate switches that electrically connect the grounding pads 233 which contact the housing of the mobile device or the electrically conductive surface of the handle 210 that is gripped by the user, or a capacitor to capacitive screen pads 232 that are positioned over the touch screen. The user thereby selectively couples this capacitance charge to the screen pads simulating a finger tap to the touch screen and thereby providing an input to the touch screen of the tablet and the software operating on the tablet.

FIG. 11 is an exploded isometric view of the handle more clearly illustrating the components that comprise the handle. The top half of each handle 210 is comprised of a top housing 211 with openings for the control switches and a top cover 212 that is secured to the top handle with fasteners 222. The bottom half of handle 210 is comprised of a bottom handle 216 and a bottom cover 215 that is secured to the bottom handle with fasteners 223. Springs 221 act on the underside of the top latch of bottom handle 216 and react against the bottom latch 217 which is secured to the top cover 212 with fasteners 224. These springs acting through the top and bottom halves of the housing and the friction pads 213 and 214 effectively and securely clamping the device onto a tablet or smart phone. Controls 219 are operated by the user and act upon silicone snap disk 235 to move a carbon pill 236 into contact with the printed circuit board 231 bridging circuits that connect to the grounding pads 233, conductive surfaces of the handle 210, or a capacitor and to individual capacitive screen pad 232. Shoulder button 218 switches a micro switch 234 that also connects a capacitive charge to a corresponding capacitive screen pad 232. Electrically conductive surface contact pads 237 couple the user's capacitance electrically to a corresponding capacitive screen pad 232 directly without a switch when the user contacts the surface contact pad 237.

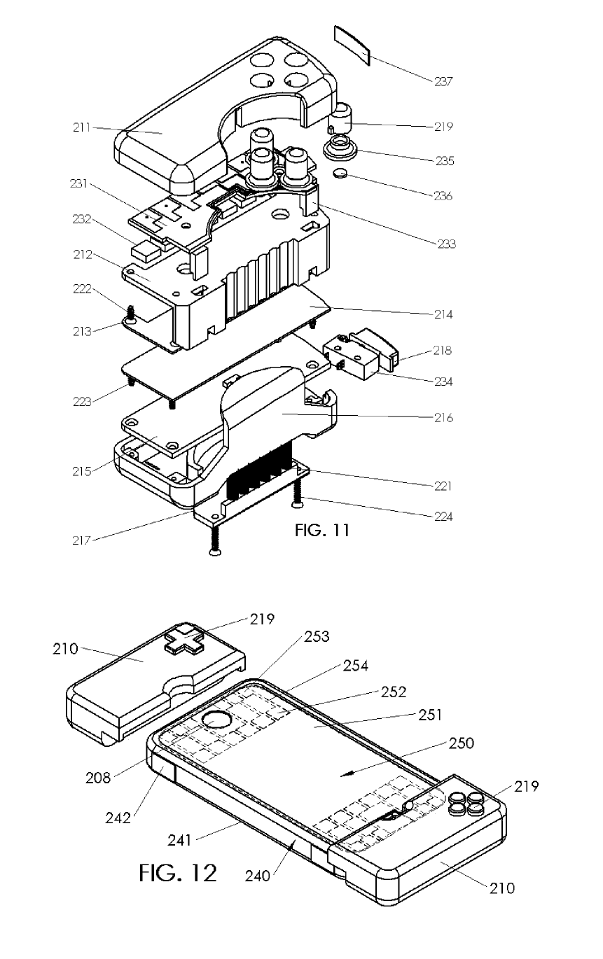

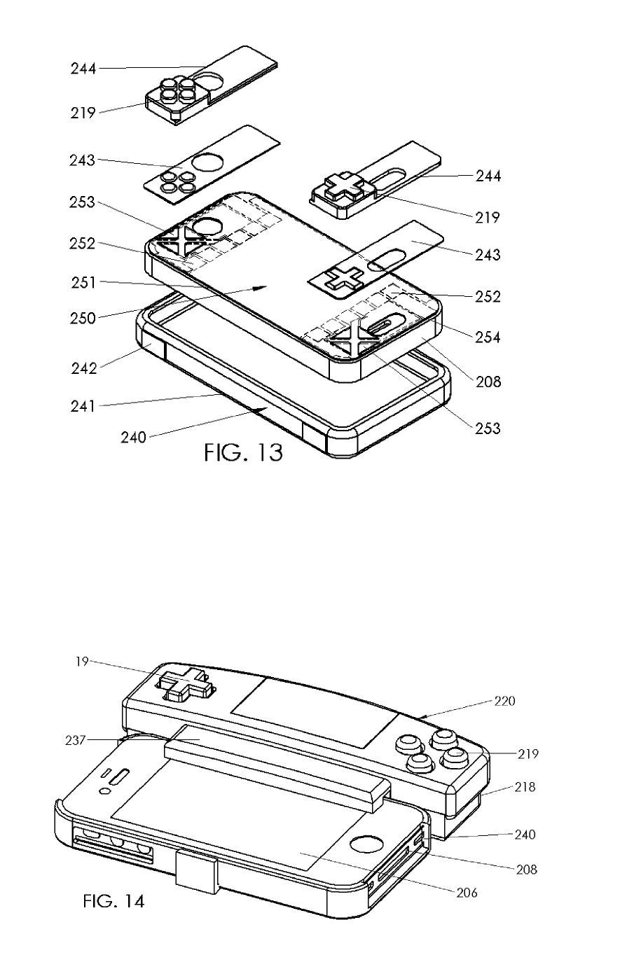

Referring to FIGS. 12 and 13, additional embodiments of the invention are comprised of a screen protector 250 with conductive electrical circuits that is applied to a smart phone or tablet 208. The screen protector is comprised of a clear film 251 with a visually transparent conductor such as indium titanium oxide (“ITO”), nanometer copper lines, or any other transparent conductor selectively plated onto the film. Transparent capacitive screen pads 252 are positioned over the clear film 251, conductive traces 254 electrically connect the screen pads 252 to transfer pads 253, controls 219 and covers 243 and 244 not located on the visible touch screen thereby effectively removing the user's fingers from obscuring the screen while they are inputting into it. The capacitive transfer screen protector may be used by itself or in conjunction with accessory components.

Referring to specifically FIG. 12, the second embodiment a conductive trace 254 couples the screen pads 252 electrically with remote transfer pads 253 that are coupled capacitively or electrically to capacitive screen pads 232 in handles 210 with controls 219 similar to those described in the first embodiment. Handles 210, with controls 219 and capacitive switching circuits and output pads as previously described in FIGS. 10 and 11, are easily attached and removed from a protective case 240. When a handle is attached to the smart phone case, output capacitive screen pads 232 are positioned over the transfer pads 253. This arrangement of pads now transfers electrical charge through control circuits operated by the user to the output pads which interact with the transfer pads 253 on the screen protector. The electric charge is thereby conducted to the screen pads 252 which capacitively interact with the smart phone screen signaling the touch screen to respond as if it had been tapped directly by the user. This embodiment of the invention allows a user to remotely signal a touch screen and operate a touch screen controlled device without obscuring the screen with their fingers.

Referring to FIG. 13, another embodiment is described that couples the screen input capacitive screen pads 254 electrically to transfer pads 253 located off the visible touch screen which the user may touch to directly input to the touch screen. A smart phone 208 is housed in a protective case 240 comprised of a shell 241 with shoulder button touch pads 242 that connect capacitively or electrically with a transfer pad 253 on the touch screen protector 250 thereby allowing the user to tap touch pad 242 with their forefinger and signal the smart phone. Membrane switch covers 243 may optionally be placed over the transfer pads 253 on the protective screen and provide a more tactile interface for the user. Conductive surfaces on the membrane pad transfer electrical charge to the transfer pads 253. To make the user interface more like a console style game controller optional switch covers 244 may be placed over the screen protector. The switch covers are electrically or capacitively coupled to the transfer pads. In a manner similar to the invention as described in FIGS. 10 and 11 the user interacts with the controls 219 which operate electromechanical switches closing circuits that conduct the capacitance to the transfer pads, through the conductive trace, to the screen pad and to the touch screen. Electrical charge is thereby transferred through the invention and interacts with the touch screen as a user's finger tap would.

Referring to FIG. 14, another embodiment is shown that combines the functions of the two handles into a single smart phone game controller 220 designed to readily and easily attach to a smart phone or a smart phone in a case. The controller 220 communicates with a smart phone through a surface contact pads 237 utilizing capacitive pads or through transparent conductors as mentioned earlier. The function of the handles described in the previous embodiments have been combined into a single controller 220 that clamps onto a smart phone 208 or a smart phone housed in a protective case 240. The housing incorporates finger controls 219 and shoulder buttons 218 the user presses to connect the user's capacitance to capacitive screen pads housed in surface contact pads 237 positioned over the smart phone touch screen 206. The screen head may contain output pads as described in FIGS. 10 and 11 or it may be comprised of a transparent film with transparent conductors as described in FIGS. 12 and 13. The construction and function of the switching and capacitance components contained within the controller 220 is similar to that described in FIG. 11.

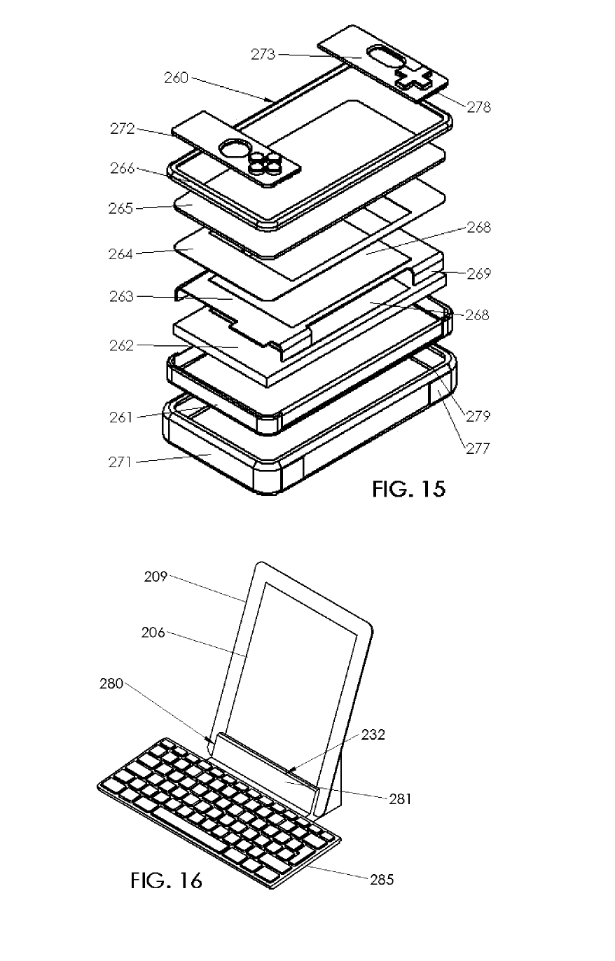

Referring to FIG. 15, an embodiment that incorporates the invention directly into a smart phone is shown. The invention eliminates the need for capacitive pads overlaying a touch screen by incorporating additional capacitive inputs into the smart phone itself. These capacitive inputs 269 receive inputs from a “smart” case 271 designed with custom user inputs 277. A preferred embodiment of the invention creates these additional inputs by extending the ITO film 263 or the conductive metal traces of a typical mutual capacitance touch screen assembly beyond the LCD screen area to adjacent areas on the ends or sides of the phone.

The smart phone 260 shown is comprised of a back cover 261, electronic components 262 with a screen 268, a unique ITO film layer 263, a mask 264 concealing the non-screen areas of the ITO layer, a glass screen cover 265, a front bezel or cover 266. The ITO layer 263 uniquely extends beyond the visible LCD screen area 268 thereby providing additional capacitive inputs 269 to sense touch capacitance on the ends and sides of the phone. This assembly creates an open architecture smart phone that communicates through remote capacitive links with a custom cover comprised of a case 271 with user inputs 277 that are capacitively coupled to the ITO capacitive sensing layer located on off capacitive inputs 269. Additional control pads 272 and 273 integrate temporarily or permanently with the case. The controls on these pads are capacitively or electrically coupled with the case through capacitive couplings or electrical contacts 278 positioned on the pads and capacitive couplings or electrical contacts positioned on the case 279. These components together allow a user to operate touch pads, console style game controls or other buttons and their inputs are communicated through the case 271 to the smart phone through the case's capacitive inputs 269.

An advantage of this arrangement in a smart phone is the simplicity and low cost of a single input panel and a single mutual capacitance controller. However the same goal can be accomplished with multiple input devices. This arrangement creates an open architecture smart phone that can be coupled with a great variety of smart phone cases configured to provide customized user inputs that communicate with the additional inputs of the smart phone. These cases may incorporate touch pads, electrical mechanical switches and other features, such as those described in other embodiments.

Referring to FIG. 16, a keyboard interface embodiment of the invention is shown. In this embodiment the invention is adapted to provide a capacitive input from a multi-key device such as a keyboard or numeric pad. This embodiment of the invention 280 holds a mobile tablet 209 for comfortable viewing by the user. A screen head 281 containing capacitive pads 232 overlaps the touch screen 206 of the mobile tablet. User inputs from a multi-keyed device such as a keyboard 285 are input into the mobile tablet using capacitive links as described in the previous embodiments.

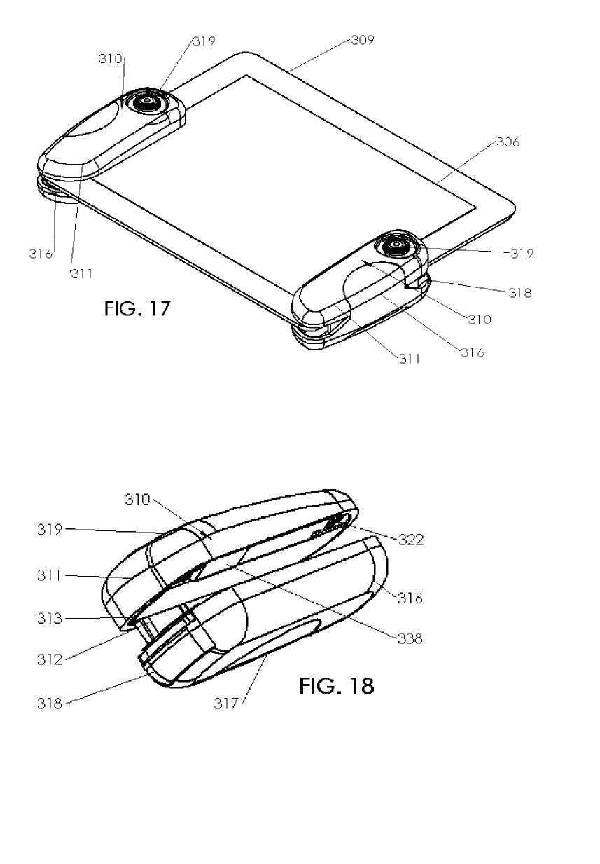

Referring to FIGS. 17-20, an easily attachable mobile tablet handle embodiment of the invention is described the handles 310 shown roughly approximates one half of a typical hand-held game player in function. The handle assembly is installed on a mobile tablet 309 or smart phone by a means that is readily attachable and detachable such as a clamp. When installed on the device a portion of the housing 310 overlays the touch screen 306 and communicates with the touch screen through a capacitive link. The user operates controls 319 and 318 on the handles similar to those found in standard console style gamepads. The invention's controls operate digital encoders and switches that connect the user's capacitance, the capacitance of the device's frame or a standalone capacitor to capacitive pads positioned on the touch screen thereby selectively transferring electrical flux to the mobile device. The invention allows the user to operate the touch screen device without touching the screen.

Referring to FIG. 17, the handles 310, right and left, are attached to a mobile tablet 309. The handles are designed to easily attach to most mobile tablets and smart phones. The handles provide an ergonometric grip and an improved method for holding a tablet and incorporate gaming console style controls 319 and 318 that switch a remote capacitive link that provides console controller style gaming input through the touch screen 306 of the mobile device.

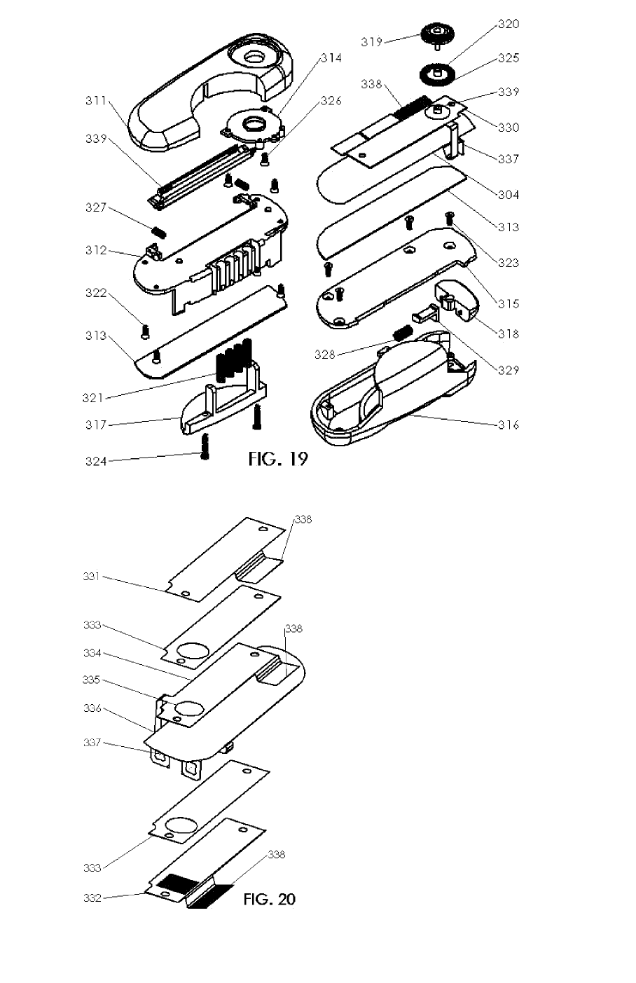

FIG. 18 more clearly illustrates the inputs and outputs of the invention. Housing 310 is designed to clamp onto the tablet and houses the input and output controls. A bottom cover 316 interlocks with and extends through top cover 311. By pressing down with the users thumb on the top of bottom cover 316 and pressing the user,s fingers on the top of latch 317 the user can separate the top and bottom sections of the handle and when released the top and bottom will clamp tablet 309.

A digital encoder operated by a thumb control 319 located on the top of the handle is generally operated by the thumb and translates the users up/down and left/right thumb motions into digital positional information on orthogonal axis. Trigger button control 318 is located at the end of the handle where the forefinger naturally wraps around the handle and uses a novel mechanical configuration to provide a good tactile experience for the user while translating the users pulling and sideways forefinger movements into dual on/off inputs. These inputs selectively switch on and off circuits that connect a conductive pad that is conductively or capacitively coupled with the device's case to conductors 338 that are positioned on the touch screen. The user thereby selectively couples electrical flux to the screen pads simulating a finger tap and swipe to the touch screen and thereby providing an input to the touch screen of the tablet and the software operating on the tablet.

Referring to FIGS. 19 and 20, FIG. 19 is an exploded isometric view of the handle more clearly illustrating the components that comprise the handle. The top half of each housing 310 is comprised of a top cover 311 with openings for the user thumb control 319 and a top assembly 312 that is secured to the top handle with fasteners 322. The bottom half of housing 310 is comprised of a bottom cover 316 and a bottom assembly 315 that is secured to the bottom handle with fasteners 323. Springs 321 act on the underside of the top latch of bottom cover 316 and react against the bottom of latch 317 which is secured to the top assembly 312 with fasteners 324. These springs, acting through the top and bottom halves of the housing and the friction pads 313, effectively and securely clamp the device onto a tablet or smart phone. A thumb control 319 extends through a post 320 to a stylus tip 339 that shorts electrical traces in flex assembly 330. A garter type spring 325 opposes the users thumb movements and returns the thumb pad to the center. The garter spring 325 and post 320 are held in position by thumb pad cover 314 which is secured to the top cover 311 by fasteners 326. Flex assembly 330 is mounted to the top assembly 312 and the flex assembly's ground pads 304 are mounted to the bottom assembly 315. Conductors 338 are mounted to the stylus tip 339 which interfaces with ramped features on top assembly 312 and springs 327 so that the stylus tip, with the attached conductive pads, is pressed into contact with the touch screen when the handle is attached and is retracted into the handle housing when it is detached to protect the conductors from damage. The trigger button control 318 is operated by the user and acts upon metal domes 337 to connect the ground pad to electrical conductors 338 placed over the touch screen. A spring 328 acts on a slide 329 to oppose the user's rotational movement of the trigger and returns the trigger to its normal centered position.

Referring to FIG. 20, the flex assembly 330 is comprised of a top layer 331 and bottom layer 332 with multiple conductors running from the encoder input area to conductors positioned over the touch screen. A spacer 333 separates the top and bottom layers from a middle layer 334 with conductive shorting pads 335 that are electrically connected to a capacitive grounding pad 336. Force applied by the user on the thumb control 319 forces stylus tip 339 into the flex assembly 330 and the flexes the top and bottom layers into the shorting pads thereby connecting the capacitive ground pad to selective conductors in an array of conductors 338 positioned over the screen. The users thumb movements thereby change the capacitance of finely pitched conductors overlaying the screen thereby emulating the sliding motion and changing position of a user's finger moving across the touch screen.

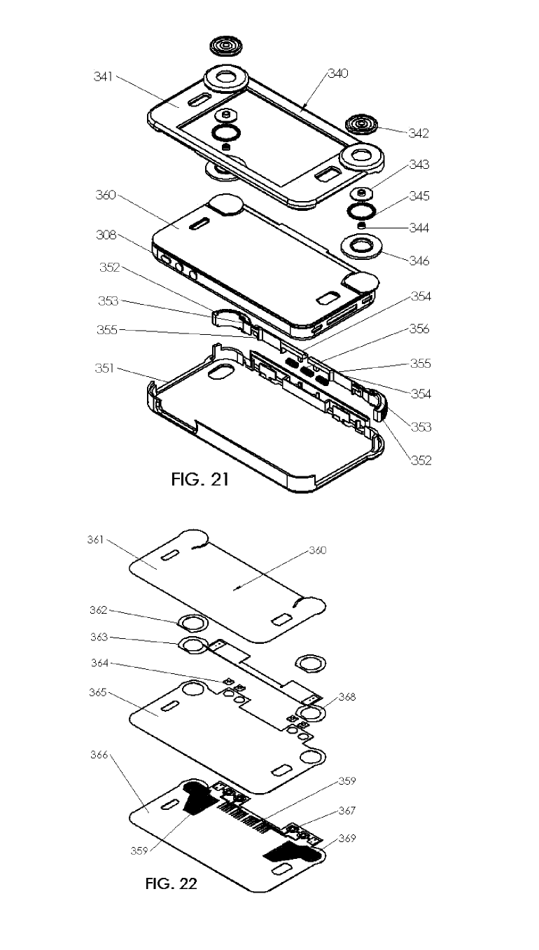

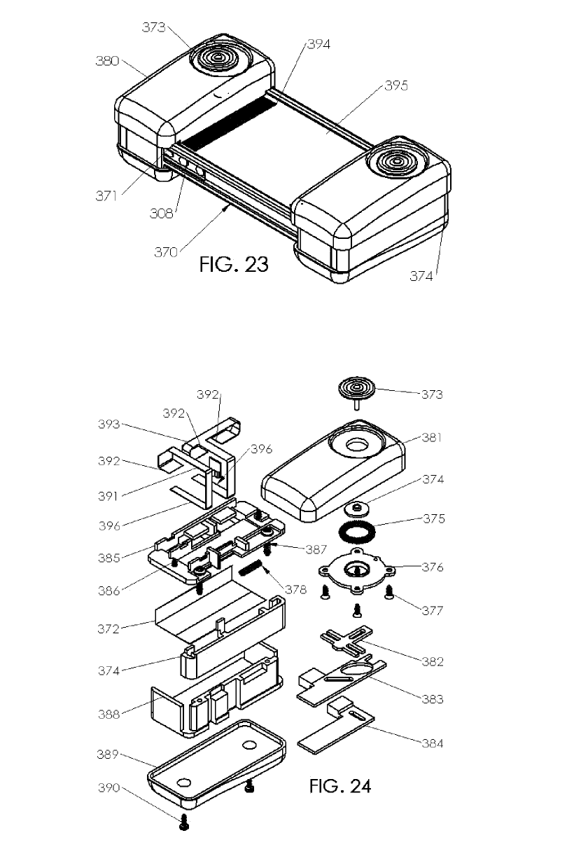

Referring to FIGS. 21 and 22, another embodiment is described that an embodiment of the invention is shown that expands the functionality of smartphone into those of a hand-held game player such as a Sony Vita or Nintendo 3DS. The invention 340 is incorporated in a smart phone case comprised of top cover 341 and bottom cover 351. The digital encoder and trigger control switches communicate with a smart phone 308 through a screen protector 360 utilizing circuits 369.

The game controller 340 is housed in top cover 341 containing the mechanical components of two digital encoders each comprised of a thumb pad 342 located on the top of the handle operated by the users thumb and translates the users up/down and left/right thumb motions into digital positional information on orthogonal axis. The thumb pad 342 extends through a post 343 to a stylus tip 344 that moves across switching circuits in screen protector 360. A garter type spring 345 opposes the users thumb movements and returns the thumb pad to the center. The garter spring 345 and post 343 are held in position by thumb pad cover 346 which is secured to thumb pad 342.

The bottom cover assembly 350 is comprised of a bottom cover 351 which contains two finger wheels 352 that the user can roll in clockwise and counterclockwise directions thereby providing dual finger inputs. The rotary motion of the finger wheels is translated into linear motion by link 353. This link connects the finger wheel 352 to a shuttle 354 with ramped features 355 that translates left/right motion into up/down motion on springs 356. These actuators press on domes 364 to close circuits 367 on screen protector 360. Springs 356 oppose the user's finger motion on finger wheels 352 and return the finger wheels to their normal centered position.

A screen protector 360 containing the circuitry of the invention is attached to the face of the smart phone 308. The screen protector is manufactured using materials and processes similar to the construction of membrane keypads. The screen protector 360 is comprised of a top cover 361 with circuitry on the underside separated from middle layer 363 by top spacers 362. Middle layers 363 is separated from bottom layer 366 by a bottom spacer 365. Shunting pads 368 are electrically connected to the case of the smart phone 308. The movements of stylus tip 344 act to short shunting pads 368 to circuits 369 positioned above and below the shorting pads. The circuits 369 extend to transparent conductors 359 positioned over the touch screen 306 of the smart phone 308. When these transparent conductors 359 are connected to the smart phone's case, or the user or an external capacitor, the capacitance sensing controller of the smart phone registers the increase in capacitance at that location just as it senses a user's touch on the touch screen.

Referring to FIGS. 23 and 24, a smartphone case 308 with removable handles 380 that incorporate moveable capacitive pads 392 is shown. The smart phone 308 is enclosed by a smart phone case 370 that accommodates normal operation of the smart phone and includes attaching features 371 that engage removable handles 380. The user attaches the handles 380 with tactile inputs that include a circle pad 373 and a trigger 374 and additional inputs as required. The trigger 374 is held in positioned by spring 378, when activated by the user, the trigger closes a membrane switch in the trigger circuit 391. Circle pad 373 extends through top cover 381 and is centered in trigger 374 that is centered by a garter spring 375 and retained by cover 376 and screws 377. The shaft of the circle pad engages moveable horizontal slide 382 which interfaces with moveable horizontal actuator 383, together they translate the user's horizontal circle pad motion into vertical motion of capacitive pads 392. The circle pad also engages moveable vertical slide 384 translating the vertical movement of the circle pad into a vertical movement of the slide and the capacitive pad attached thereto. These movable members 382, 383 & 384 reside in a housing 385 which accepts screws 386 that fasten the top cover 381 and screws 387 that fasten the side 388. Bottom cover 389 is secured to the assembly with screws 390 that attach to side 388. The horizontal actuator and vertical slide have features that attach to capacitive pads 392, on circuit 393 with downward and sideways facing conductors that capacitively couple with the touch screen 306 either directly or through transparent conductors 394 that are on optional screen protector 395. Without the screen protector the capacitive pads 392 must overlay the screen. With the screen protector 395 the handles do not overlay the screen, they overlay the transparent conductors 394 which overlay the touch screen and remotely project the capacitive signals onto the screen. Cover 372 covers and encloses the capacitive pads 392 protecting them. Both circuits 391 and 393 have capacitive pads 396 that capacitively couple to the case of the smart phone 308 and are electrically coupled to the capacitive pads 396.

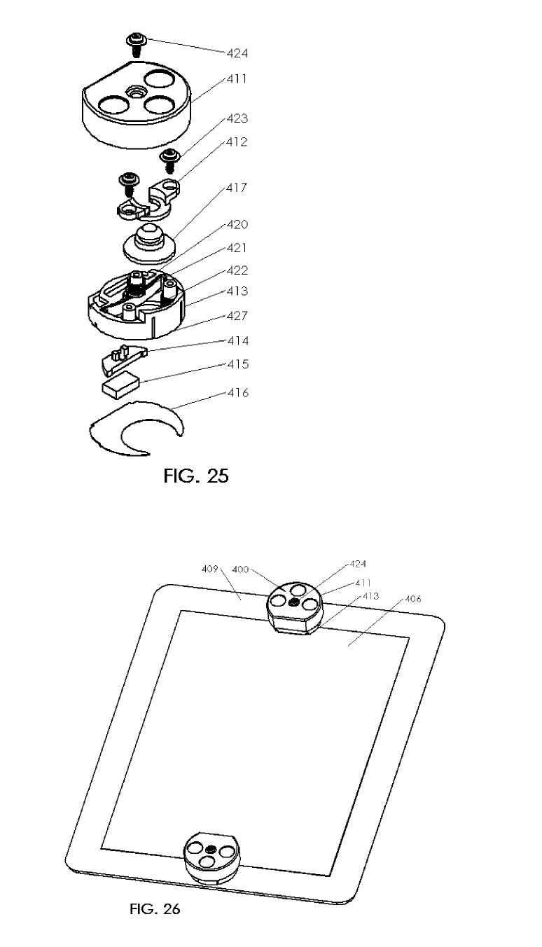

Referring to FIGS. 25 and 26, a rotary input embodiment of the invention is described. A knob type rotary controller 410, similar in input function to a Pong controller, is shown attached to a mobile tablet 409. The invention is comprised of a rotatable knob 411 secured to a base 413 by screw 424. A suction cup 417 incorporated into the base attaches the to the mobile tablet. Springs 422 act on suction cup holder 412 whose motion is limited by screws 423 and firmly press the base against the touchscreen device. The vacuum in the suction cup is released by deflecting a tab 417 on the base into and under the suction cup.

Conductive coatings on the knob 411 conduct the user's rotary input motion and capacitance to a shuttle 414 which operates in a linear slide 418 and is attached to a conductive pad 415 which is secured in place and protected by a cover 416. Multiple devices might be used by multiple players to play against an opponent on the tablet PC.

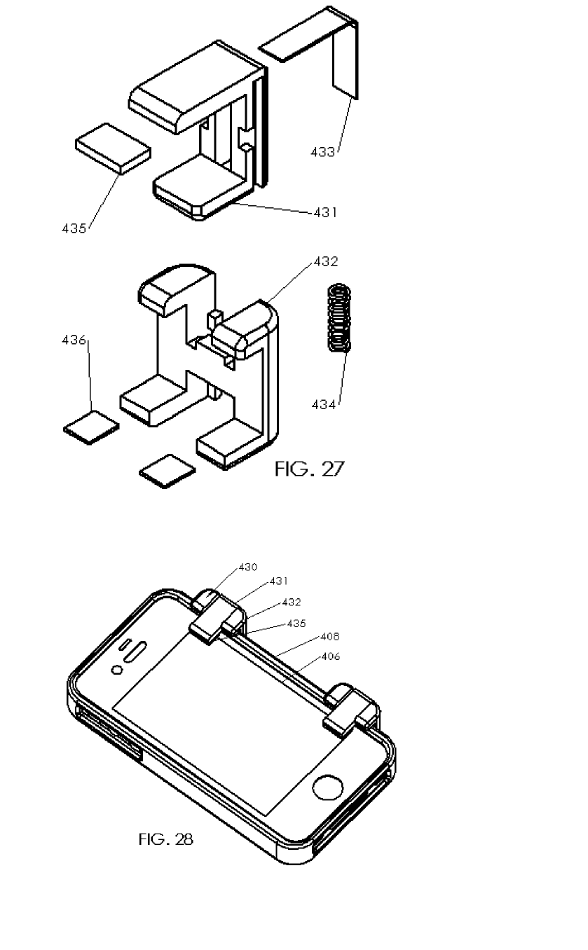

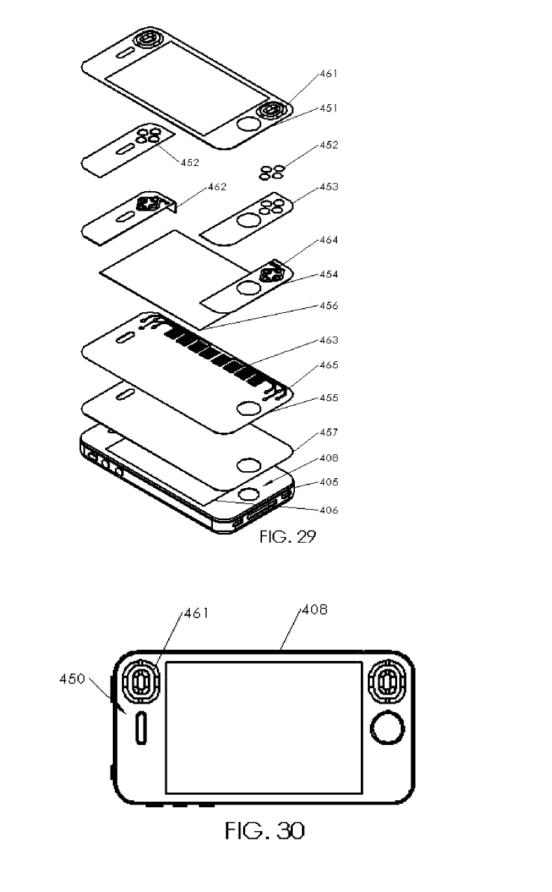

Referring to FIGS. 27 and 28 a very low cost spring clip embodiment of the invention is described. An easily attachable trigger 430 is shown attached to a smartphone 408. The conductive pad 435 on the trigger overlays the touchscreen 406 preferably in the corners. A user holds the phone as depicted in FIG. 2 and touches the contact 433 which electrically connects the user to the conductive pad 435 thereby coupling the user's capacitance to the touchscreen.

A spring 434, acting on top clip 431 and bottom clip 432 presses the conductive pad 435 and the optional friction pads 436 against the smartphone 408. The clip is opened by squeezing on the top of the bottom clip and the bottom of the top clip thereby compressing the spring and opening the clamp.

Referring to FIGS. 29 and 30, the invention is shown incorporated into a screen protector 450 shown attached to a smartphone 408. The top most component is a cosmetic overlay 451 with embossed tactile features 461 that transmit the users input to flexible domes 452 that are located by spacer 453. The domes short upper circuit 464 on upper layer 454 with circuit 465 on bottom layer 455. Conductive tab 462 attaches to the smartphone housing 405 and connects with the upper circuit. Transparent conductors 463 positioned over the touchscreen 406 connect with the lower circuit. When the dome shorts the circuits the capacitance of the smartphone case is coupled to conductive pads and the touchscreen is activated. Protective cover 456 protects the assembly and the smartphone touchscreen. Releasable adhesive 457 attaches the screen protector 450 to the smartphone. Adhesives are used as required to bond the layers together.

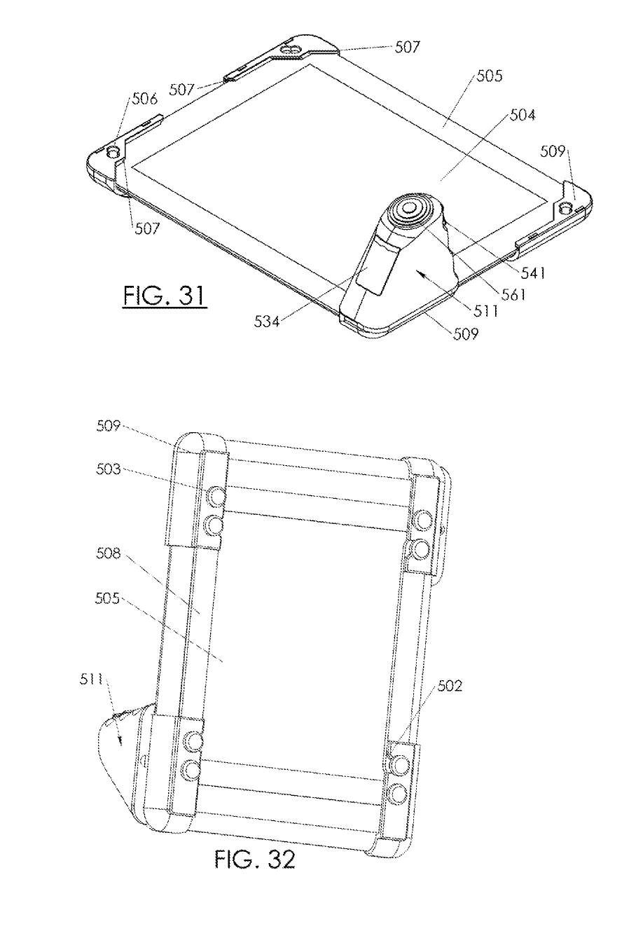

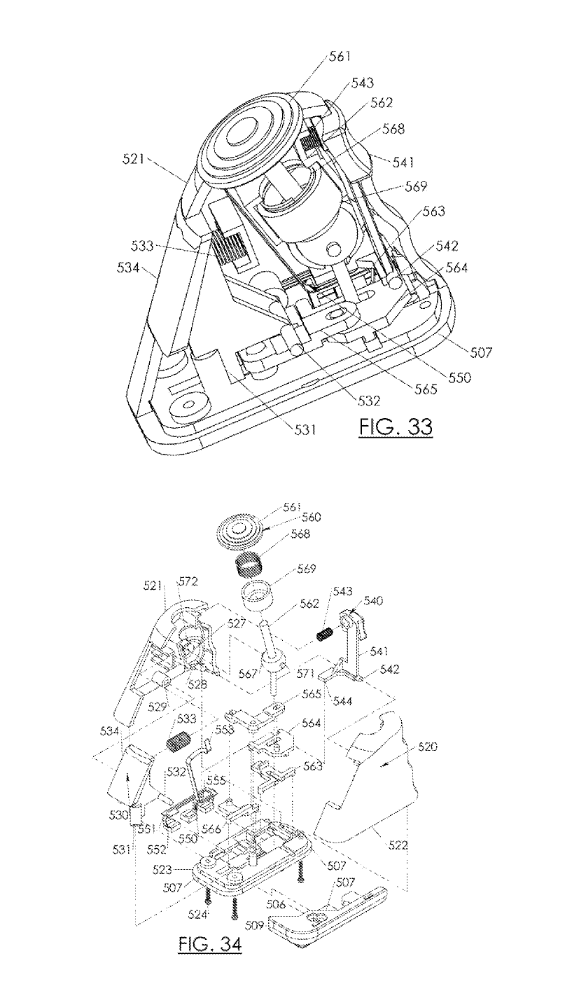

Referring to FIGS. 31-34 a graspable joystick embodiment of the invention 511 and a mounting system 510 are shown. The invention translates a tactile input through a thumb pad 561 to a capacitive input recognized by the touchscreen 504 of tablet 505.

The invention 511 attaches to protective mounting system 510 that is comprised of a corner bracket 509 that is secured to a tablet 505 by elastic bands 508 that attach at holes 502. The corner brackets attach to the elastic bans by buttons 503 that also serve as protective feet. The user is able to easily attach the system by sliding the buttons in to notched hole 502.

To attach the invention 511 to the case system the user places it on the screen and slides it into the bracket corner. Overlapping features 507 in the bracket guide the device into a locking position were latch pin 531 is forced into latch hole 506 by latch spring 533. To remove the invention 511 the user pushes inward on latch release button 534 which pivots the latch 530 about its axel 532 which resides in housing boss 529 thereby removing latch pin 531 from latch hole 506. The user can now disengage the overlapping engagement features 507 by pushing the device 511 out of the corner bracket 509. The case system 510 allows the invention, which may be embodied in multiple forms, to be attached in each corner and is adaptable to either portrait or landscape orientation. The invention may also be attached by clamp, suction or other means as shown in previous embodiments.

The invention is comprised of housing 520 with fixed members housing sides 521 and 522, and housing base 523 secured to the housing sides by screws 524. The housing also includes moveable members comprised of one or more operable triggers 540 and a latch 530. The trigger 540 is a finger operated tactile switch comprised of a trigger lever 541. When the user presses hard enough overcome the force of trigger spring 543 the trigger lever 541 rotates about its axel 542 which pivots in boss 528. The users input movement thereby causes trigger actuator 544 to operate one or more switches 555 which are part of flexible electronic assembly 550.

Flexible electronic assembly 550 is comprised of circuits 551, conductive pads 552, switches 555 and electric charge source antennae 553 arranged as best suited for establishing a capacitive link with the tablet. A joystick control assembly 560 translates the user's two axis input into single axis movements of the conductive pads 552 on the touchscreen 504. A thumb button 561 drives a linkage 562 that transfers the users up/down movements to a vertical slide 563 that moves a conductive pad 552. The linkage transfers the user's right/left movements to a horizontal slide 564 that connects to an arm 565 that translate the motion to driver 566 which moves a conductive pad 552. Centering spring 568 acting through spring cup 569 on linkage 562 centers the linkage and provides tactile resistance to the user's input. Linkage 562 has a pivoting ball interface 567 that resides in a socket 527 formed into housing side 521 & housing side 522. Pivot axel 571 operating in slot 572 prevents pivot rod 562 from rotating.

Collectively theses components of the invention translate the user's physical inputs to electric circuits that capacitively couple with the mobile device's touchscreen altering the local capacitance of the touchscreen causing the touchscreen controller to recognize a touch event and return position and motion information to the application.

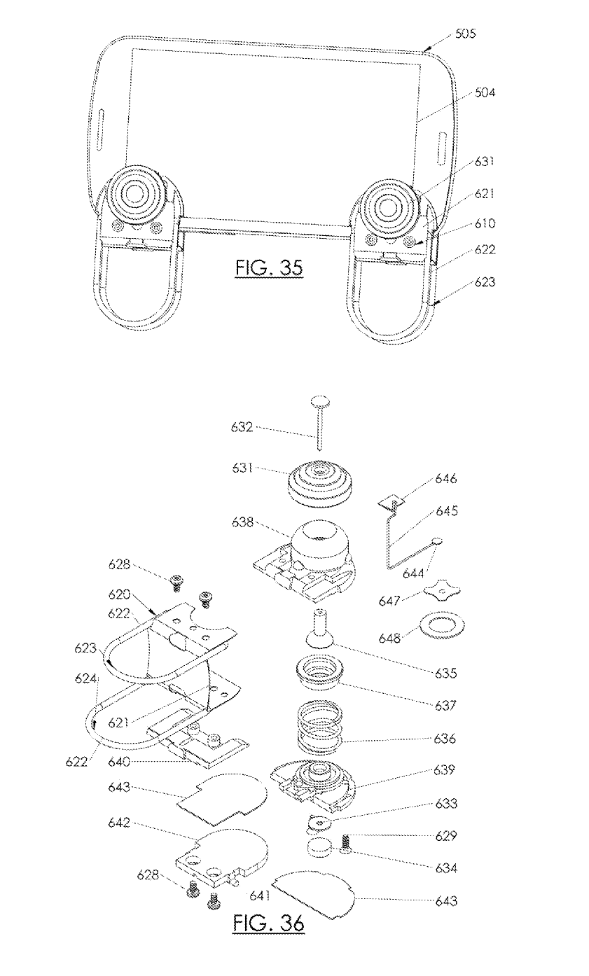

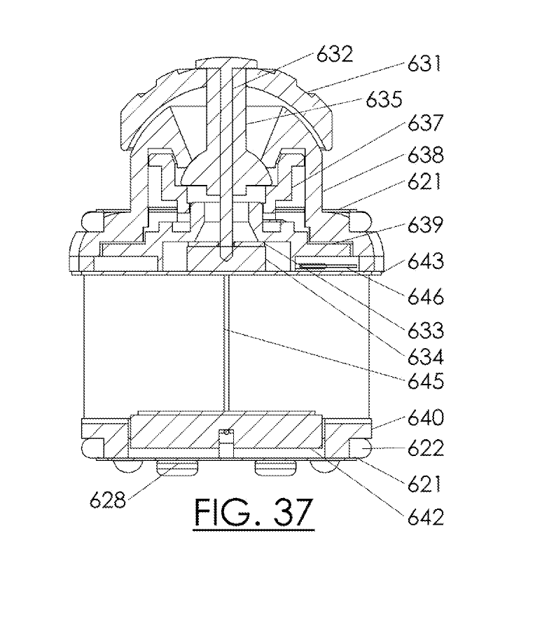

For use on a smartphone or small tablet the overall size and screen overlay of the device must be as small as possible. FIGS. 35-37 illustrate an embodiment scaled and modified for smaller touch screen devices.

In thumb control embodiment 610, the invention is attached to the mobile device 505 by an attachment system 620 comprised of clamp spring 621 attached by screws 628 or other suitable means to joystick assembly 630 and a lower arm 640. The clamp spring 621 is expanded by positioning levers 622 in a deployed position 623 and squeezing them together. For storage the levers can be slid and flipped 180 degrees to a stowed position 624 to minimize the storage size of the invention. Pivot pad 642 with axels 641 which are held between clamp spring 621 and lower arm 640 is free to rotate to distribute the applied force of clamp spring 621 evenly against the backside of the mobile device 511 through lower friction pad 643 which provides high friction and protects the surface of the mobile device. A trigger contact 644 is positioned on the pivot pad 642 or lower arm 640 and selectively conducts the user's capacitance through conductor 645 to trigger pad 646 positioned against touchscreen 504. The user's tactile interaction with the trigger contact 644 is enhanced by snap dome 647 held in place by ring 648 or other suitable combination of components with forces, surfaces and motions that provide tactile feedback to the user.

The joystick assembly 630 houses components that translate the user's thumb motions to a two axis touchscreen input. The user positions their thumb on cap 631 and pin 632 which couples the user's capacitance to washer 633 and thumb pad 634. Cap 631 is attached to pivot rod 635. Spring 636 acts through spring cup 637 on pivot rod 635 which pivots in housing 638 to center the pivot rod 635 and cap631 and further provide tactile resistance to the user's up/down and right/left input motions. The force of spring 636 is reacted by retainer 639 which is secured to top housing 638 by screws 629 or other suitable fastening means. Features on the retainer 639 keep thumb pad 634 parallel to and in close contact with the touchscreen 504 of mobile device 505. Upper friction pad 649 provides high friction with the mobile device surface and retains thumb pad 635 in retainer 639. The relative distances of the pivot rod center to the user's thumb and the thumb pad interface with the touchscreen allow the user a wide range of motion while providing the motion required lateral motion required to provide a high resolution signal to the touchscreen.

Collectively the components of both devices translate the users thumb input to a touchscreen input which conveys high resolution position and motion information to the application operating on the device.

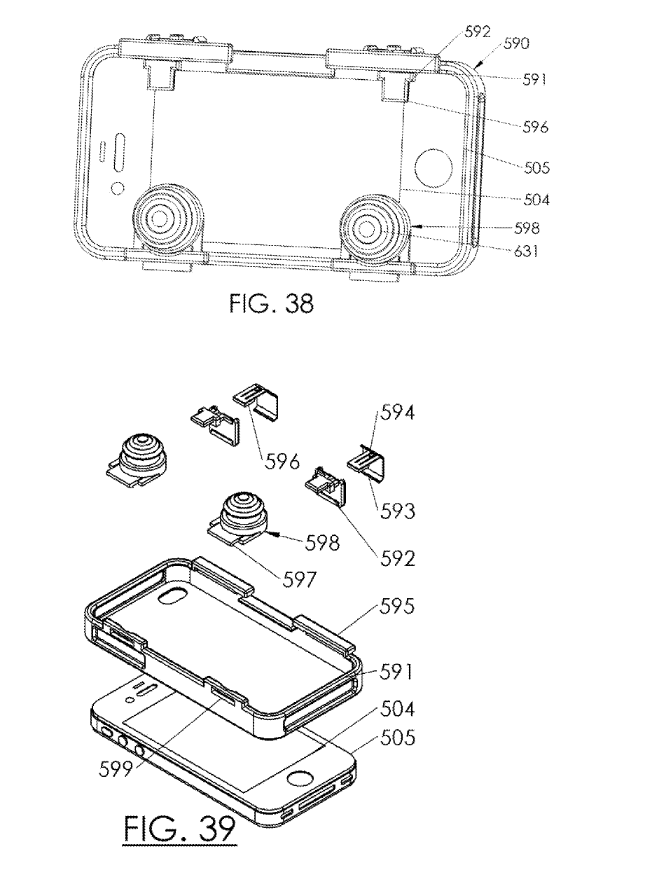

In FIGS. 38-39 the invention is embodied in a smartphone case controller 590 with sliding user input controls 592 that are operated by the user's forefingers. These controls slide along the edge of the smartphone case 591 providing proportional input for instance, in a car driving game one slide would be used to turn left-right the proportional input would tighten the turning radius the further the control is move from its center position. The other control would be used for acceleration-braking, the further the control is moved from its center position the faster the car speeds up or slows down. Tapping the input controls would provide additional momentary or binary inputs.

The input controls are positioned to allow the user to easily hold the smartphone and to use their thumbs for accessing screen inputs. As such the invention would additionally augment input to texting, mapping and other applications.

In this embodiment a flat spring 593 exerts force between the input control 592 and the case 591. The user's input motion moves the input control 592 and a spring loaded feature 594 of flat spring 593 along a contoured surface 595 with ramped and notched features. The interaction of the spring loaded features and the contoured surface 595 would provide tactile position feedback to the user and allow the input control to be securely parked off the screen when not in use. Various combinations of springs, ramps, detents and features can be used to provide tactile location feedback and maintain the input control position or return to a preferred resting location.

The flat spring provides a capacitive coupling between the user and capacitive pad 596 which capacitively couples with the touchscreen 504 of the smartphone 505. Variations on this embodiment could include capacitive or conductive coupling directly to the case of the smartphone or other capacitive sources.

This case could also include features that allow joystick assembly 598 similar to thumb control embodiment 530 but configured without a trigger input to directly attach to a smartphone case 591. A tab 597 slides into a mating feature 599 thereby locating and securing the joystick assembly 598 against the mobile device screen 504.

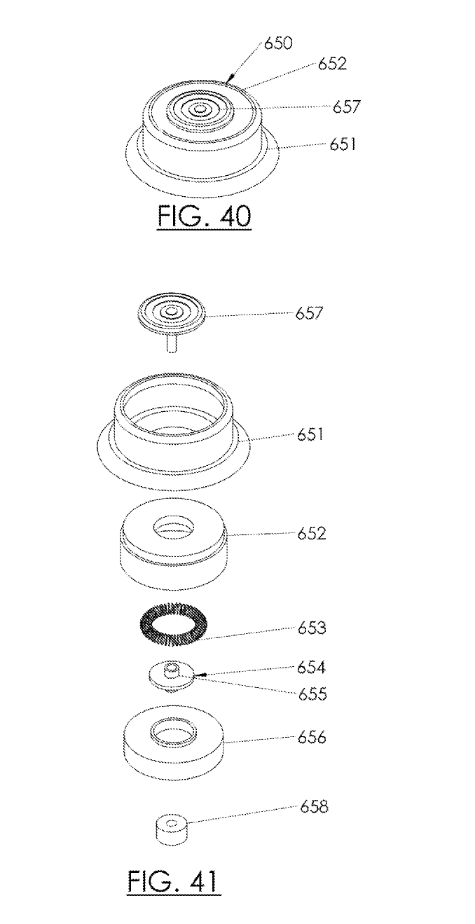

FIGS. 40-41 show a suction cup attachable circle pad embodiment of the invention 650. This embodiment is comprised of annular suction cup ring 651 that fits over the body 652 in which axial garter spring 653 encircles the flange 654 of post 655. Cover 656 captures the pad and garter spring. Cap 657 extends through post 655 to mechanically and electrically connect with pad 658 which presses against the touchscreen of a mobile device. Garter spring 653 centers the cap and provides tactile resistance to the users input. In a similar manner, annular suction cup 651 or a micro suction cup pad may be applied to previous embodiment joystick 598 or other embodiments of the invention.

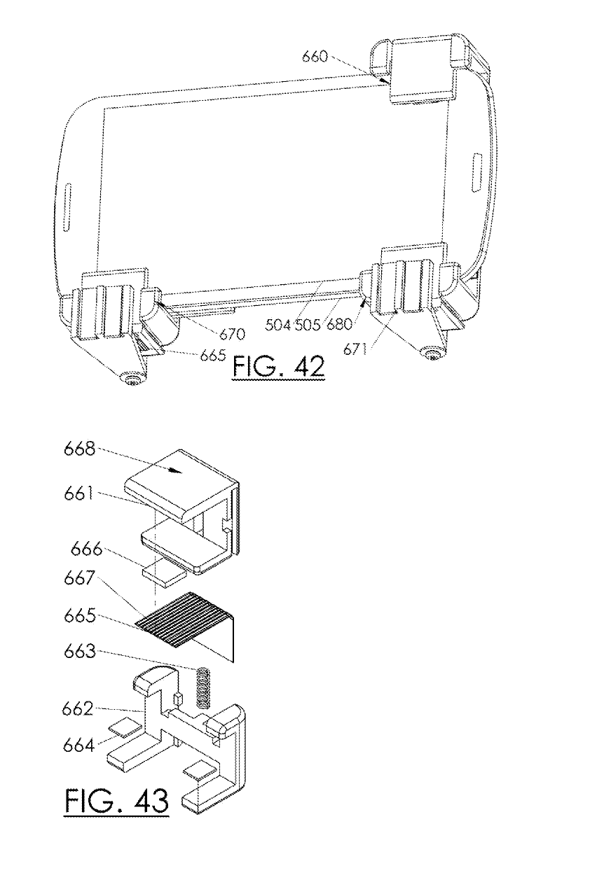

FIG. 43 shows a touch input single axis embodiment 660 embodiment of the invention. The invention moves the user's finger input off the touchscreen and is comprised of a top clamp 661 and a bottom clamp 662 acted upon by clamp spring 663 arranged to apply a clamping force to a mobile device through various friction pads 664 and surfaces to secure the invention to the mobile device. Flex ribbon 665 is pressed against the touchscreen of the mobile device by conformable pad 666. The capacitance of the user is transferred to the screen by finely pitched conductors 667 in flex ribbon 665. The conductors capacitively or conductively coupled to the user change as the user moves their finger across the ribbon perpendicular to the conductor paths. This change of position and motion is thereby conveyed to the screen by the conductors. The flex ribbon may be positioned for contact by the user on any surface such as the top surface 668 of top clamp 661 that provides a favor interface with the user.

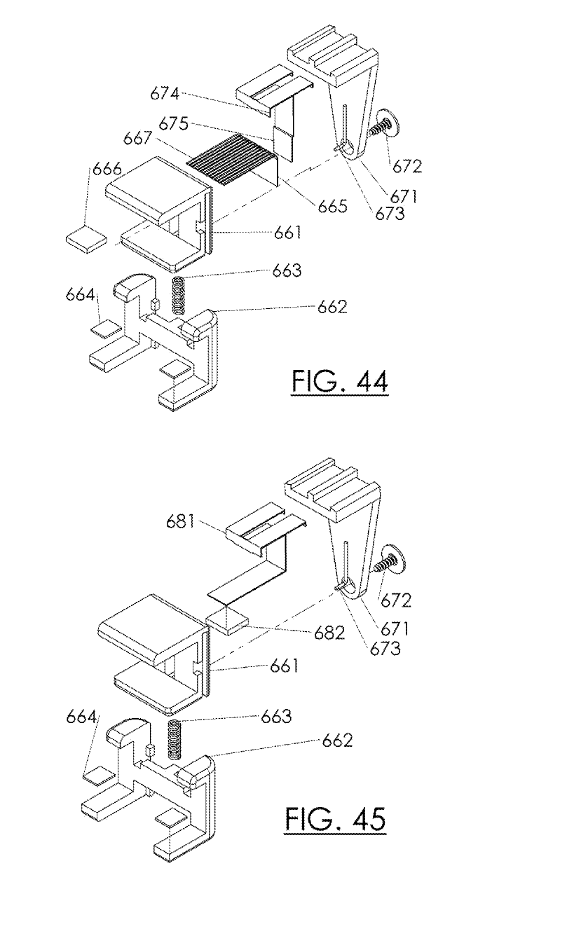

The FIG. 44 shows a single axis pivot 670 embodiment of the single axis touch input 660 modified for a more tactile interface with the user. The invention includes a pivot arm 671 secured by a screw 672 or other suitable means to top clamp 661. A centering spring 673 resists the input motion of the user and returns the arm to a centered position. Clip 674 capacitively or conductively couples the user to a conductive pad 675 that capacitively or conductively couples with conductors 667 in flex ribbon 665 thereby transferring the user's capacitance to the screen. Alternately conductive pad 675 could be capacitively or conductively coupled to the case of the mobile device or a separate capacitor. The positional resolution of a flex overlay is generally one half the conductive trace pitch. For a finer resolution a conductive pad is moved across the screen.

FIG. 45 shows a single axis pivot screen contact 680 embodiment of the single axis pivot 670 modified for direct screen contact without a flex ribbon. Attached to screen clip 681 is a conductive pad 682 that extends over the touchscreen. Screen clip 681 capacitively or conductively couples the user to conductive pad 675 which moves across the touchscreen as the user moves pivot arm 671.

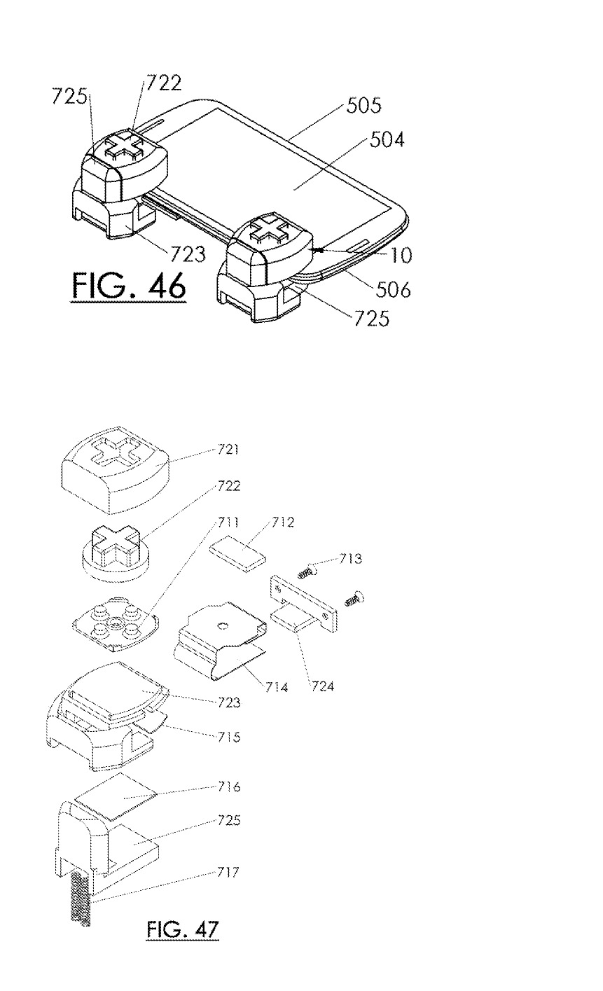

Referring now to FIG. 46 a directional pad embodiment of the invention 710 is shown. The invention translates a tactile input applied to an input button 722 into a capacitive input recognized by the touchscreen 504 of a touchscreen device such as a smartphone 505.

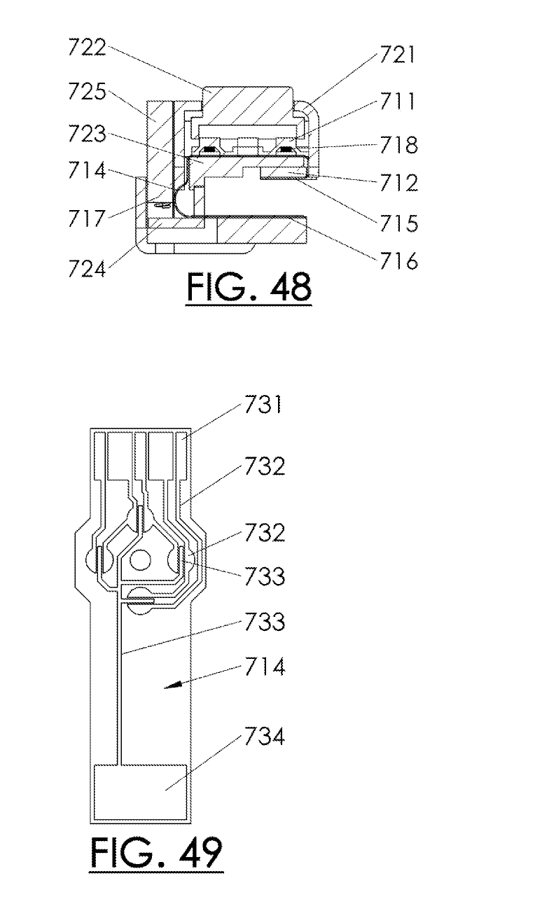

Referring now to FIGS. 46-49 the components of the invention 710 are illustrated. A main housing 723 overlays the touchscreen 504 of mobile device 505 and is opposed by clamp 725 which is acted upon by springs 717 which react against cover plate 724 which is attached to housing 723 by screws 713 thereby clamping the mobile device between the housing and the clamp. Friction pads 715 and 716 have a high coefficient of friction and attach to housing 723 and clamp 725 respectively.

Film circuit 714 is formed and positioned on housing 723 so that conductive pads 731 are placed over the touchscreen and held firmly against the touch screen by resilient pad 712. Shorting contacts 718 in membrane pad 711 electrically connect screen circuit paths 732 from screen pads 731 to ground circuit paths 733 from the capacitive ground pad 734 which is attached to clamp 725 and electrically or capacitively coupled to the mobile device case 506. Alternately the capacitive ground pad may be coupled to the user or a separate capacitor.

When the user presses on one of the four distal edges of input button 722 their movement forces a dome of resilient material such as rubber to collapse and contact 718 shorts screen circuit paths 732 to a ground circuit path 733. The completed circuit capacitively couples the capacitance of the ground pad to the touchscreen which generates a touch signal which is recognized by the mobile device.

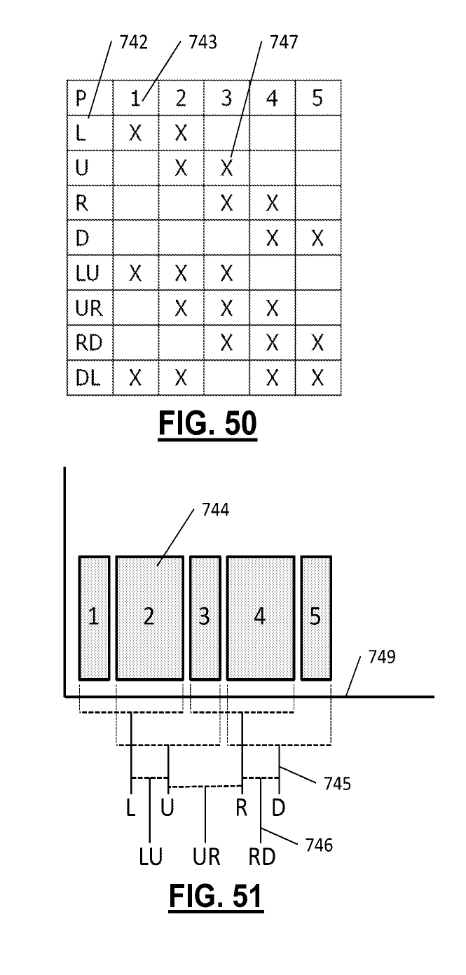

Referring to FIGS. 50 & 51 the discrete input locations generated by the multiplex pattern of coupled capacitance pads is illustrated. Column P in FIG. 50 lists the four ordinate positions 742 commonly found on a directional pad type video game controller. Where L=left, U=up, R=right, D=down are basic inputs and combinations of adjacent inputs are possible where LU=left+up, UP=up+right, RD=right+down and DL=down+left. The remaining column headings 743 refer to the five pads capacitively coupled to the touchscreen device and an “X” 747 indicates those pads activated for each input.

Touchscreen controllers provide the location of a touch as the center of the measured area with a capacitive signal. A minimum area with minimum capacitive values is required to be recognized as a touch. The five capacitive pads 744 are sized and located near the borders of a touchscreen 749 such that any combination of two adjacent pads will generate a distinct touch signal centered across the combined width of the two pads 745. When adjacent inputs are simultaneously operated, three adjacent pads are activated generating a distinct signal centered across the combined width of the three adjacent pads 746. Pad 3 is wide enough to provide enough separation between pads 2 and 4 so that when an L input activates pads 1 and 2 and a D input activates pads 4 and 5, two simultaneous distinct L and D signals are generated and recognized by the application as the combined DL input. While the pads may all be equal in size the arrangement shown whereby pads 2 and 4 are approximately 2× the width of pads 1, 3 and 5 provides the narrowest overall footprint on the touchscreen.

The multiplex arrangement in the preferred embodiment uses five pads activated in pairs by membrane contacts in a membrane switching arrangement but the invention may be configured with discrete multiple pole switches or other switching means. Additional pads may be used such as seven pads activated three at a time, etc. But the lowest number of pads will be the number of inputs plus one.

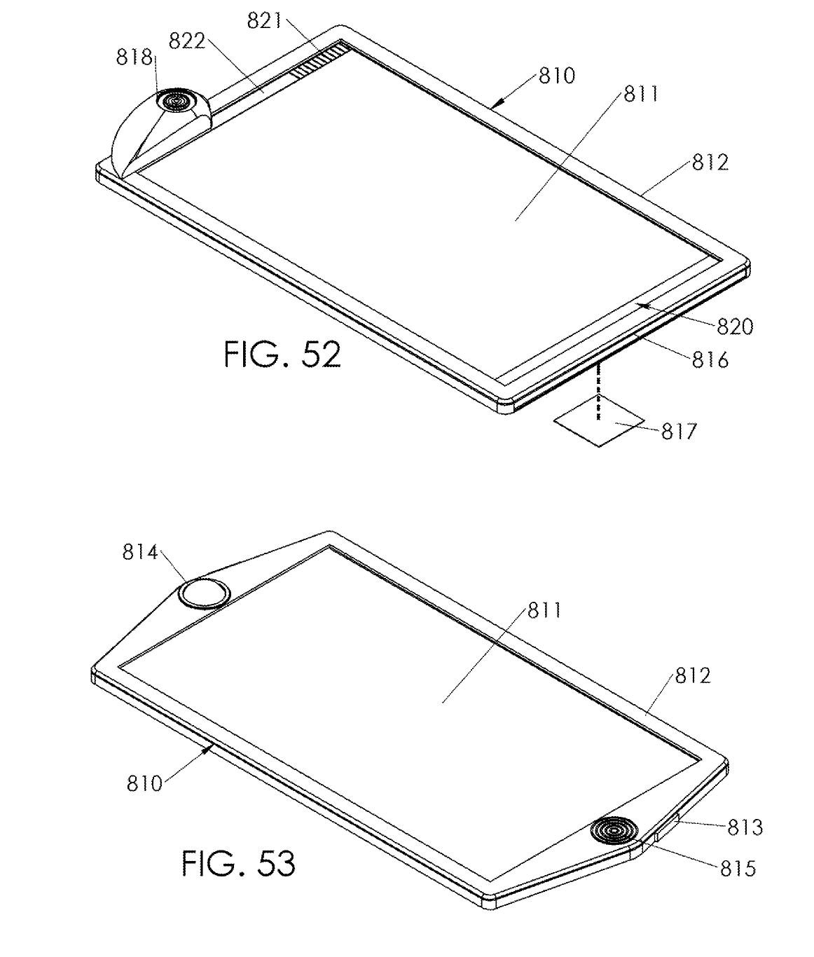

Referring to FIGS. 52 and 53 a handheld personal computing device or tablet embodiment of the invention 810 is shown. The invention is comprised of a video screen 811 held in a rigid frame 812 with touchpad 820 preferably comprised of a conductor 821 printed on transparent film 822 placed around one or more borders of the video screen. Preferably such borders will be the width of a finger and provide a single axis of input. The device may also include supplemental user inputs such as a touchpad located on the tablet front side 815 for easy contact by the user's thumb or on the edge 816 or backside 817 for contact by the user's forefinger. Such inputs may also be tactile such as a trackball 814, shoulder button 813, slider, trigger, switch or other input device. Optional tactile input to touch input controls 818 may be used to enhance the user input for specific applications such as games.

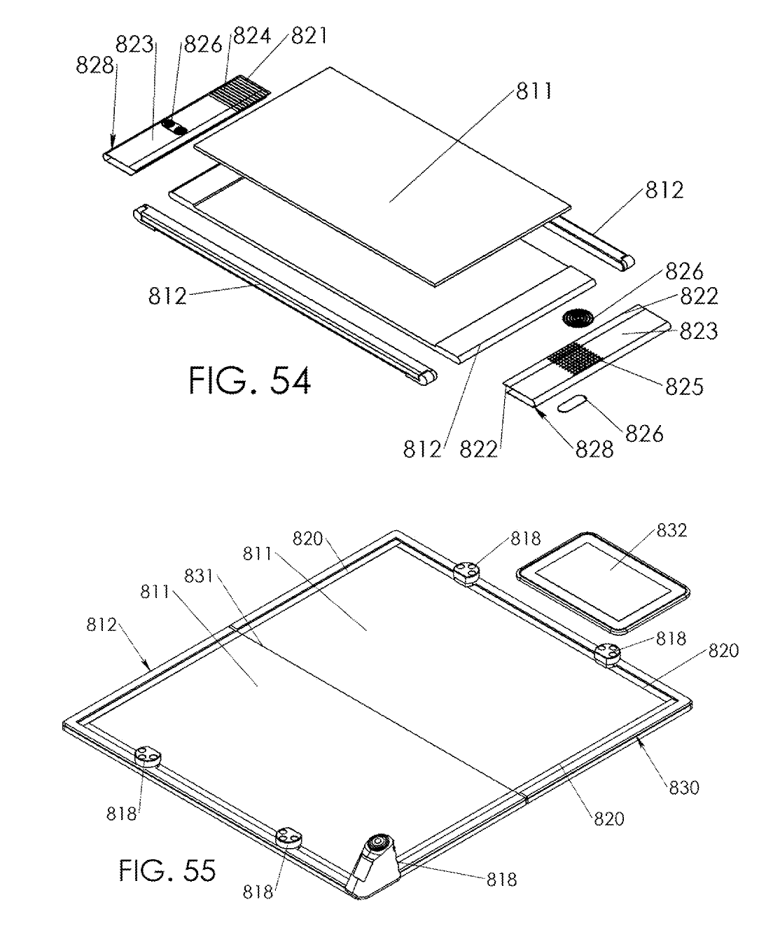

Referring to FIG. 54 a tablet embodiment of the invention is shown where the touch pad 828 includes a transparent film 822 that overlays the screen and an opaque film 823 that overlays portions of the tablet frame with conductors 821 common to both areas of the touchpad. The opaque area could wrap around portions of the edges and back of the frame to lower cost and simplify construction. The touch pad 820 can include single axis touch areas 824 and two axis touch areas 825 with input suitable for navigating the full video screen.

Such an expanded touch pad area would facilitate user customization of designated touch areas that could be further augmented by tactile stickers 826 or other surface preparations that help the user tactilely locate and navigate those areas of the touchpad. Such inputs might also be mounted to rotate or articulate to further improve ease of use and ergonometrics.

Referring to FIG. 55, a table top video game platform or monitor embodiment of the invention 830 is shown, comprised of a video screen 811 which is comprised of one or more parts for easy storage such parts coupled by a hinge 831 or otherwise configured to conveniently attach, detach and store. A computer that runs the application programs is incorporated into the video screen or is provided by a linked mobile device 832.

The invention is comprised of a video screen 811 held in a rigid frame 812 with touchpad inputs 820 preferably comprised of transparent conductors printed on transparent film placed around one or more borders of the video screen. Preferably such borders will be the width of a finger but could be wider and provide two axis of input. Optional tactile input to touch input controls 18 may be used to enhance the user input for specific applications such as games.

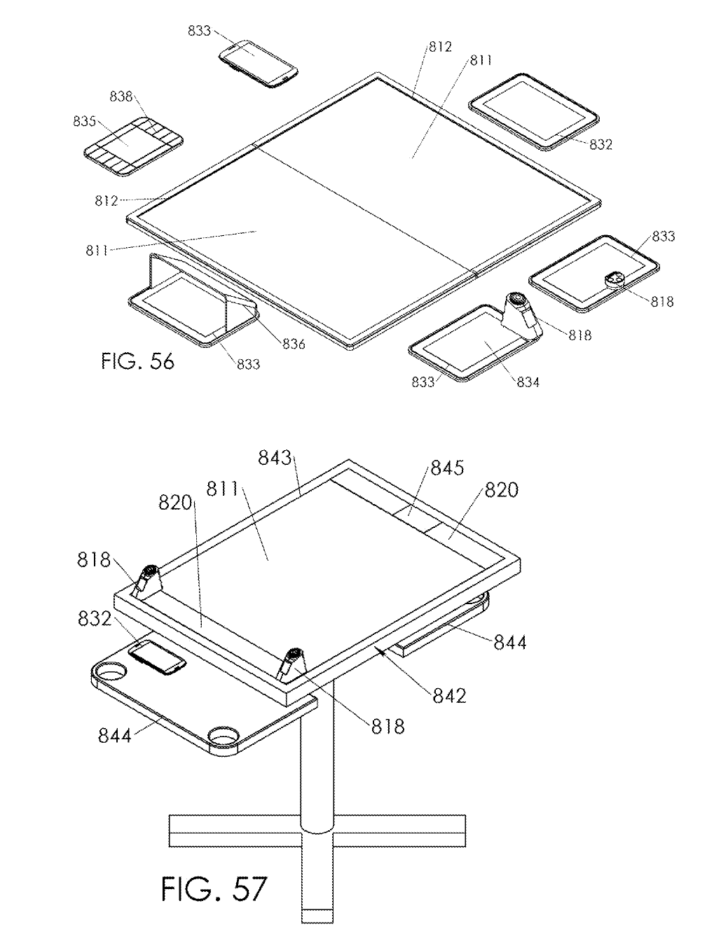

Referring to FIG. 56, the table top video game platform or monitor embodiment of the invention 830 shown in FIG. 55 is shown and each player has access to a mobile device 833 preferably with a touch screen 834 or a touchpad 835 that is linked to the master device or a touchpad 832. Each mobile device or touchpad may use tactile input to touch input controls 818 and other accessories such as a privacy shield 836. Touchpads 835 may operate common or discrete onscreen objects or characters 837 and may incorporate a clear overlay 838 with visible lines and tactile features defining specific user inputs.

Referring to FIG. 57 a table top game platform embodiment of the invention 840 is shown wherein the invention is comprised of a video screen 811 held in a rigid table 842 with a protective glass top 843 and with touchpad inputs 820 preferably comprised of transparent conductors on transparent film placed around one or more borders of the video screen or a protective glass cover 843. These touchpad inputs can be operated by the user's touch and couple with tactile input to touch input controls 818. Preferably such borders will be the height of a typical laptop touchpad so that an area 845 may be designated for providing extended touch navigation of the entire screen. A master computer that runs the application programs is incorporated into the video screen or is provided by a linked mobile device 832. A moveable tray to accommodate food and drink 844 is optionally attached to the table.

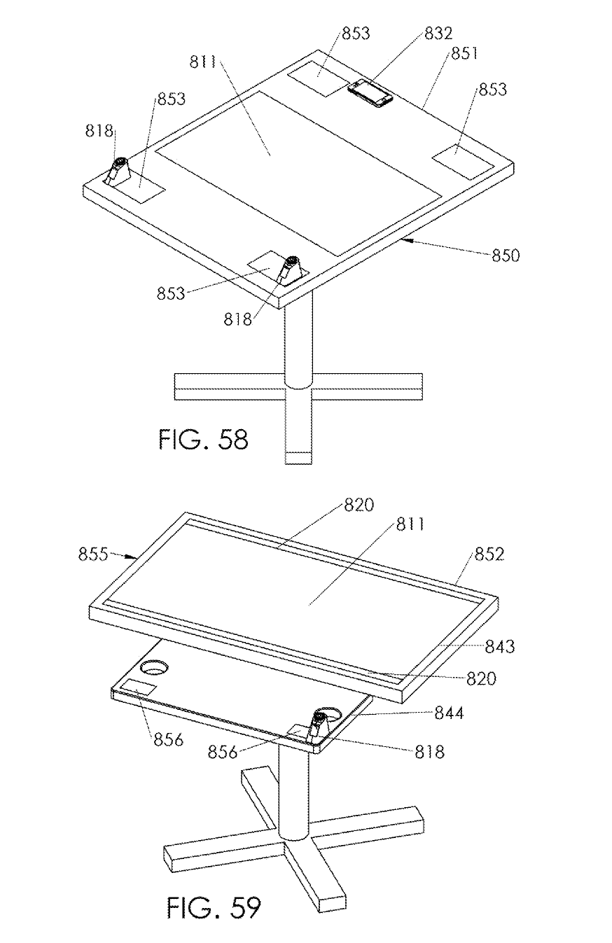

Referring to FIG. 58, a multiple screen, table top game platform embodiment of the invention 850 is shown. The invention is comprised of a table top 851 with a monitor 811 protected by a glass cover 843 and one or more touchpads or touchscreens 853 conveniently located for user access while providing space for food and drink on the table top. Application programs are run by a computer incorporated into the table or by a linked mobile device such as a smartphone 832 which receive input and provide output to touchpads and touchscreens 853 which accommodate tactile input to touch input controls 818.

Referring to FIG. 59, an alternate table top embodiment of the invention 855 is shown wherein the table top is completely covered by video screen 811 and therefore not available for food and drink. The video screen or a glass top 843 protecting the screen may or may not include a touchpad input 820 adjacent to one or more borders of the screen. A slide out tray for food and drink with one or more touchpads or touchscreens 856 with or without a tactile input to touch input control 818 attached provide additional inputs.

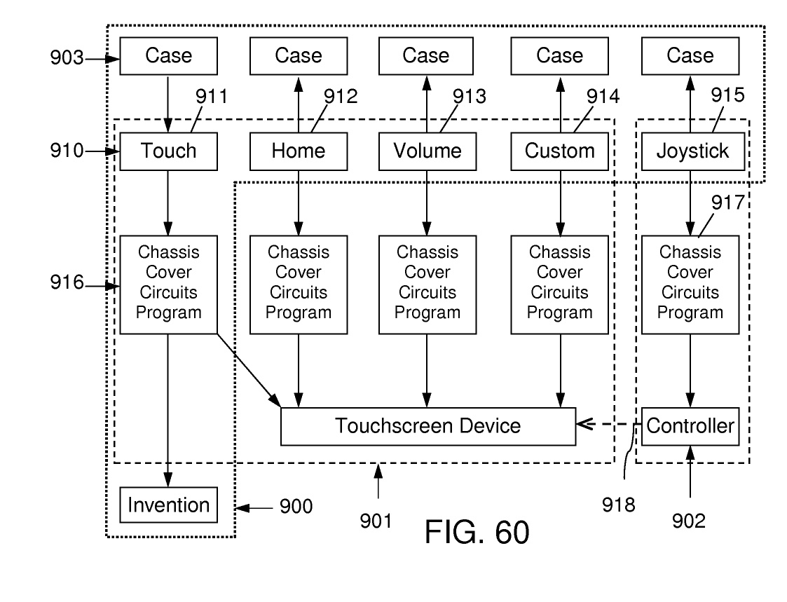

With reference to FIG. 60, a schematic diagram illustrates the user input architecture of the invention 900 and contrasts it to the user input architecture currently used in a typical smartphone, tablet or touchscreen device 901. Current devices place the user inputs 910 such as the touchscreen 911, home 912, volume 913, and other custom 914 controls in a device with shared elements 916 such as a chassis encased in a cover, and containing circuits and programming. Changes in the user inputs 910 of the device require redesign and changes in all of these elements 916 and the tooling to produce them. Because of this user input architecture the number of device input options are generally limited and changes are infrequent.

Added functionality such as that required for playing video games has to be added through a separate device 903. A typical mobile device video game controller is comprised of separate controls such as a joystick 915 residing in a separate device 903 with separate elements 917 and communicates with the device 901 through an alternate input subsystem 918 such as USB, Bluetooth, NFC or Wifi.

In contrast the invention 900 places one or more touch inputs such as the touchscreen 911 in a device with a single set of elements 916 and uniquely places the user inputs 910 in a common case 903 that communicates through a single input such as the touchscreen 911 to the invention 900. In the invention, changes to the user inputs 910 and adding user inputs such as game controls 915 are limited to the case 903 and not to the elements 916 of the device. The case 903 is typically constructed of molded plastic with simple printed circuitry therefore the cost for changes to the case is much lower than changing all of the elements 916 in device 901.

Further, in the invention 900 adding additional controls such as a game controller 915 is simplified as it only requires adding them to the case 903 and eliminates the need for a separate device 902 with its chassis, cover, wiring and programming 917 and further eliminates the need for an additional extended communication protocol with the device 978 and thereby eliminates the need for the application running on the device to access the information through an additional communication protocol.

The functionality of the case 903 may further be increased by providing for attaching, detaching and interchangeability of inputs 910 of the case. By way of example, a user who plays video games only 20% of the time and may find it desirable to be able to remove a portion of the case housing the game controls 915 when not playing video games.

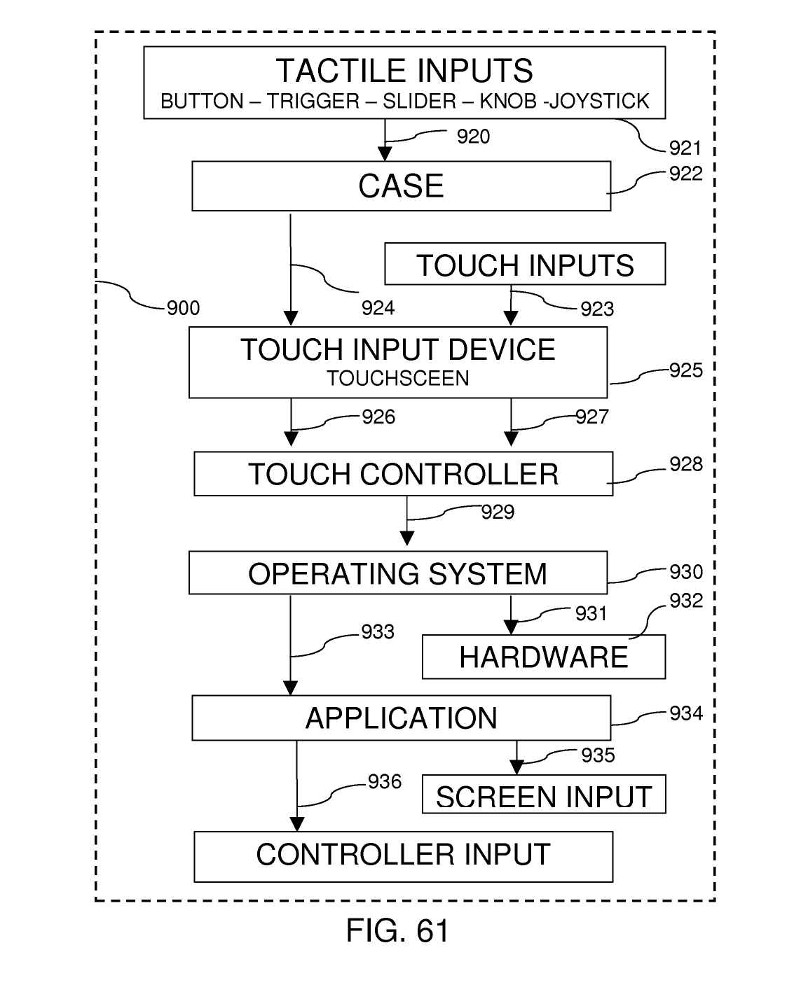

FIG. 61 illustrates the flow of information in a device with the tactile user input architecture of the invention 900 of FIG. 60. Information 920 generated from the user's various tactile inputs 921 is aggregated into the case 922 and converted into information recognizable by one or more touch inputs 924 of the device such as a touchscreen 925. The touchscreen also recognizes the direct user touch inputs 923. Raw touchscreen electrical information from the tactile inputs 926 and from the direct touch inputs 927 is conveyed to the touch controller where the touch inputs 924 from the case 922 along with direct touch inputs 923 of the user are converted to touch event information 929 by the touchscreen controller 928. Typically touch event information 929 is compiled as orthogonal x-y coordinates corresponding to a pixel map of the viewing screen along with start and stop time.

The touch event information 929 is supplied to the operating system 930 which filters the touch event information for information relevant to the device hardware 931, such as volume, which it processes and the hardware 932 utilizes in the operation of the device. The information relevant to the application 933 is supplied to the application 934 running on the device. The application 934 sorts the incoming touch event information 933 recognizing that information with coordinates that are within the viewing area of the display screen 935 are direct touch screen information that tie to the onscreen image and recognizing that touch events that are outside the viewing area of the display 936 are tactile inputs 921 from the controls in the case 922 attached to the invention 900.

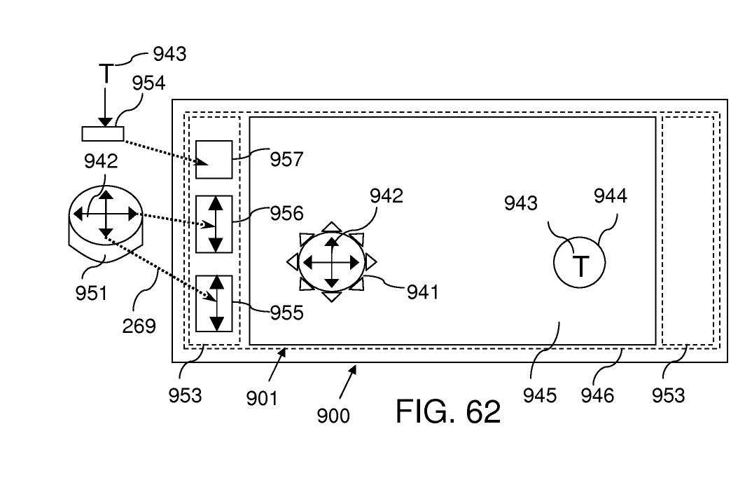

FIG. 62 further describes and compares the touch screen inputs of a typical device with an expanded device utilizing the invention 900. On a typical mobile device 901 with a capacitive touch screen 945 the user input for a joystick 942 is accomplished by placing a finger on a screen image 941. Since there is no tactile feedback the user must watch their finger and its placement on the image to make sure they place it substantially on the image and that it does not move off the image. The application running on the device will receive information from the users touch and must have substantial programming code to infer that the touch information provided to it is operating the virtual joystick especially as the user's finger invariably drifts off the onscreen location of the control. To operate a trigger the user must typically input a tap 943 on over a trigger image 944.

In contrast, the invention accepts the users input 942 through a physical typically spring centered joystick 951 providing tactile feedback through the user's finger and hand which requires no visual attention and creates no visual distraction for the user. The joystick 951 is constructed as previously disclosed to mechanically and electrically convert the user's physical finger input 942 into capacitive signals 952 that are conveyed to a touch sensitive area 953 of the device. The user's trigger input 943 is established through a physical button or trigger 954 providing tactile feedback and optional auditory feedback from a clicking sound.

In this example the two axis orthogonal joystick input 942 is transformed into individual proportional x-axis 955 and y-axis 956 inputs which simplify the touch sensor panel 946, the information supplied to the application and the programming code required. The trigger input 943 is transformed into a binary input 957. The additional touch sensing areas 953 used by the invention can be provided by extending a typical touch sensor panel 946 beyond the viewing area or by additional touch sensors optimized for the invention.

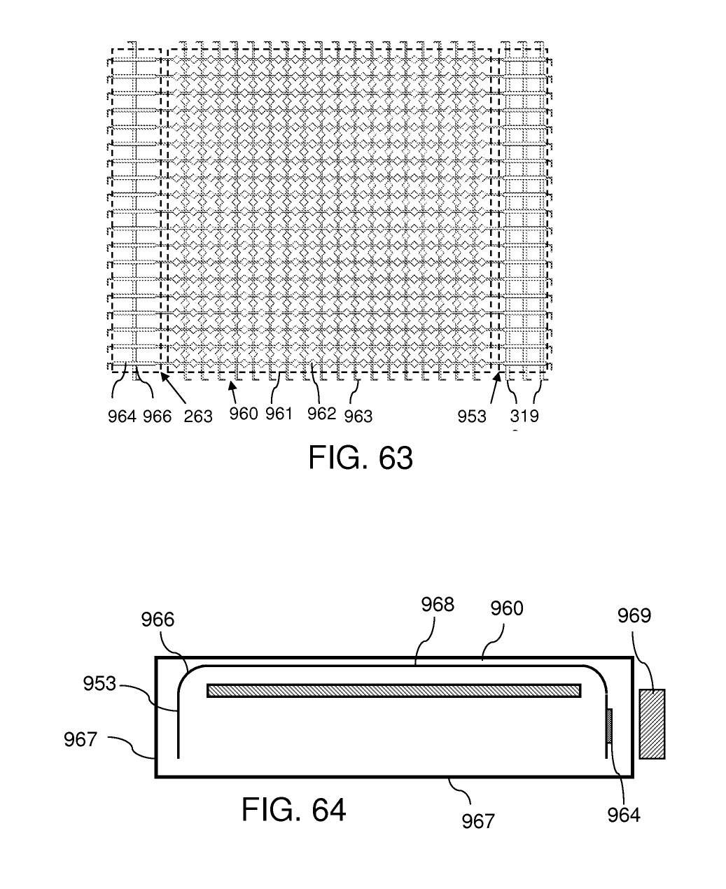

FIG. 63 illustrates of an embodiment of the invention in a mutual capacitance touch sensor panel 960 with additional touch sensitive areas 953 containing enhanced conductive pathways 964 that are optimally patterned to sense the capacitive inputs of joystick 951 and the various tactile controls presented in previous disclosures.

The mutual capacitance touch sensor panel 960 is comprised of a transparent area 961 that resides over the viewable area of a video display and is typically constructed of a grid of patterned drive and sense lines 962 fabricated from a transparent conductor such as ITO. Outside the transparent viewable area 961, visible conductors 963 such as silver connect the ITO grid lines 962 to the touchscreen controller. Additional conductors can be added individually 966 to collect additional single axis information or in an array 965 to collect orthogonal information.

Referring now to FIG. 64, the advantage of the arrangement of touch sensor panel 960 can be seen more clearly. Shown is a cross section view of an embodiment of the invention shown in FIG. 63 with touch sensor panel 960 placed within a device housing 967 enclosing display 968. Because the extended touch sensitive areas 953 do not use ITO which is brittle and use flexible conductors such as silver the extended touch sensitive areas 953 can be bent to wrap inside the sides 967 of the housing they are contained in. And because the capacitive pads of the invention 969 and the additional conductors 964 capacitively couple more strongly than a finger on the touchscreen there can be more separation between them.

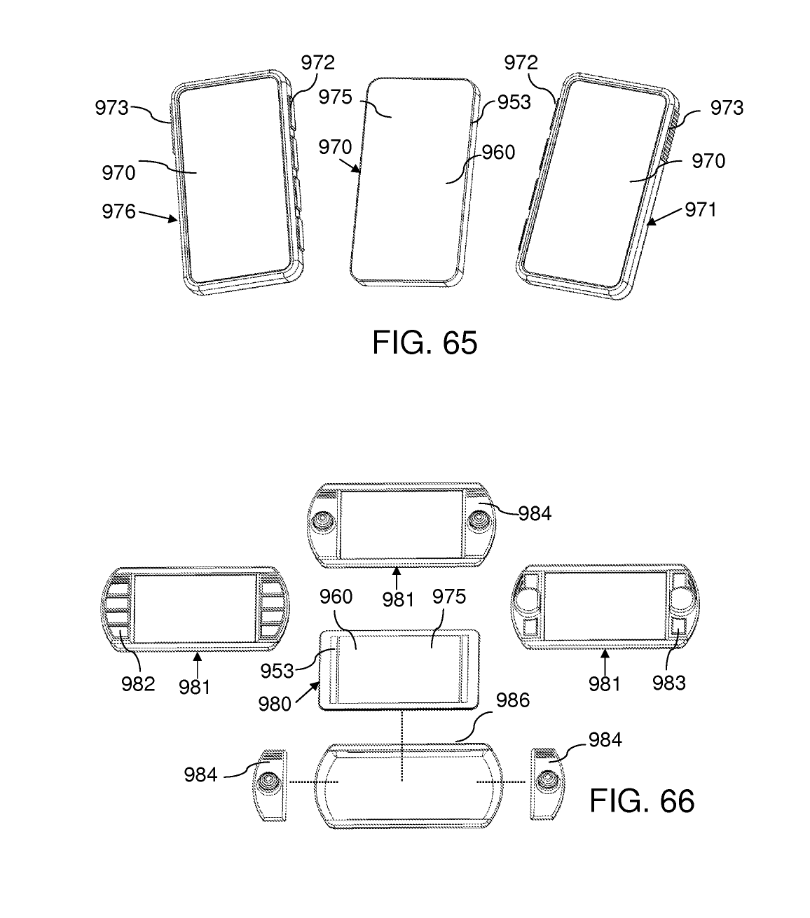

Referring now to FIG. 65 the ability to readily customize the invention is illustrated. An embodiment of the invention is shown with a smartphone type core device 970 with touchscreen 975 incorporating touch sensor panel 960 with touch sensitive areas 953. This core device 970 may be placed in case 971 with a sliding thumb control 973 and multiple binary finger buttons 972. Typically such controls would require a force to operate and would provide tactile feedback. This configuration would allow the user to operate the device with one hand, scrolling or zooming with the thumb control 973 and making input selections with the finger buttons 972. The case 971 would typically be constructed of plastic with printed circuits activated by the controls and providing capacitive signals to the touch sensitive areas. Because the costs of the case are very low, both right 971 and left hand 976 versions of the case can be easily manufactured and will interface with the common core device 970.

Referring now to FIG. 66 the ability to readily customize the invention is further illustrated. An embodiment of the invention is shown with a tablet type core device 980 with touchscreen 975 incorporating touch sensor panel 960 with touch sensitive areas 953. The device may be placed in a case 981 with a back cover 986 holding interchangeable user input controls suitable for playing and learning such as large tactile buttons 982, knobs and buttons 983 or joystick and trigger controls 984.

Because the cost of the interchangeable controls is very low cases 981 can be uniquely branded and sold with individual applications and the core device 980 can be reused repeatedly adding to its value to the user and benefiting the manufacturer by extending the core device's relevance in the market place.

I claim:

1. An interface for a device having a touch screen comprising:
a housing which can be attached to said device,
at least one input control attached to said housing,
at least one conductive pad attached to said housing,
at least one capacitive source attached to said housing,
said at least one conductive pad configured to capacitively couple with said touch screen,
said at least one capacitive source configured to couple through at least one of capacitance or electrical conduction with at least one of the case of said device, or the user of said device, or a separate capacitor,
circuitry within said housing connecting said at least one capacitance source to said at least one input control to said at least one conductive pad,
said circuitry creating a touch signal on said touch screen from the user's input.

2. The interface of claim 1 wherein said at least one conductive pad being moveable in response to said input control.

3. The interface of claim 1 wherein said at least one conductive pad is incorporated in a transparent touch screen overlay.

4. The interface of claim 1 wherein said at least one input control and said at least one capacitive source are the same feature.

5. The interface of claim 1 wherein a portion of said circuitry is incorporated in a transparent 20 touch screen overlay.

6. The interface of claim 1 wherein said housing is in two parts, each part being connected to opposite sides of said device.

7. The interface of claim 1 wherein said housing is comprised of a pistol grip type handle and said at least one input control is comprised of a trigger, wherein said pistol grip type handle and said trigger are arranged to resemble and operate similar to a pistol.

8. The interface of claim 1 wherein said housing is a protective case for said device having a touch screen.

9. The interface of claim 1 wherein said housing further comprises at least one of a touch screen overlay or screen protector.

10. The interface of claim 1 wherein said housing includes a separate transparent touch screen overlay.

11. The interface of claim 1 wherein said at least one input control has a game pad style configuration.

12. The interface of claim 1 wherein said at least one input control is a rotatable knob.

13. The interface of claim 1 wherein said at least one input control is a joystick.

14. The interface of claim 1 wherein said at least one input control is a thumb pad which moves in the same manner as a joystick.

15. The interface of claim 1 wherein said at least one input control is a keyboard.

16. The interface of claim 1 where said at least one input control is at least one of a touch pad or contact.

17. An interface for a device having a touch screen comprising:
a housing which can be attached to said device,
at least one input control attached to said housing,
at least one conductive pad attached to said housing,
at least one conductor applied to said device
at least one capacitive source attached to said housing,
said at least one conductor configured to capacitively couple with said touch screen
said at least one conductive pad configured to couple through at least one of capacitance or conduction with said conductor,
said at least one capacitive source configured to couple through at least one of capacitance or electrical conduction with at least one of the case of said device, the user of said device, or a separate capacitor,
circuitry within said housing connecting said at least one capacitance source to said at least one input control to said at least one conductive pad,
said circuitry creating a touch signal on said touch screen from the user's input.

18. The interface of claim 17 wherein said at least one conductor is transparent.

19. The interface of claim 17 wherein said conductor is incorporated in a least one of a transparent screen overlay or screen protector.

20. An interface for a device having a touch screen comprising:
a touch screen including a touch sensitive area extending beyond the visible screen area,
a housing which can be attached to said device,
at least one input control attached to said housing,
at least one conductive pad attached to said housing,
at least one capacitive source attached to said housing,
said at least one conductive pad configured to capacitively couple with said touch 1 sensitive area,
said at least one capacitive source configured to couple through at least one of capacitance or electrical conduction with at least one of the case of said device, the user of said device, or a separate capacitor,
circuitry within said housing connecting said at least one capacitance source to said at least one input control to said at least one conductive pad,
said circuitry creating a touch signal on said touch sensitive area from the user's input.
